(19) United States
(12) Patent Application Publication
(10) Pub. No.: US 2005/0282530 A1
(43) Pub. Date: Dec. 22, 2005

(54) Communications device and method comprising user profiles matching between compatible devices

(76) Inventor: Adam Raff, Crowthorne (GB)

Correspondence Address: NIXON PEABODY, LLP, 401 9TH STREET, NW, SUITE 900, WASHINGTON, DC, 20004-2128, US

(21) Appl. No.: 10/517,441

(22) PCT Filed: Apr. 16, 2003
(86) PCT No.: PCT/GB03/01647

§ 371 Date: Jul. 21, 2005

(30) Foreign Application Priority Data
Jun. 11, 2002 (GB) 0213373.4

(51) Int. Cl. H04M 3/00

(52) U.S. Cl. 455/418

(57) ABSTRACT

A communications device comprising a memory adapted to store at least one profile of a user of the device, wherein the said at least one profile contains predetermined attributes and requirements of the user, a communicator adapted to exchange information with a compatible device; a controller adapted to register a match between information sent by the said device and information received from a compatible device, only when said requirements match attributes of the said compatible device and the said attributes match requirements of the said compatible device; and a user alert adapted to alert a user when the controller has established that a match has been made; wherein the said communicator is adapted to receive information relating to the requirements from the said compatible device, and not said information relating to the said attributes.

This invention relates to a communications device and method for sending information between compatible such communications devices.

Many people experience problems meeting new people who share common interests. Typically this is due to shyness or lack of confidence. Often it is because of an inability to locate or identify suitable individuals. For example, a person who lives in a big city and who is looking for a relationship based on casual sex may walk past many suitable potential partners, all similarly desiring casual sex on a daily basis. However, it is extremely unlikely that such a person would identify the potential partners that come into proximity at all, let alone interact with them. It is not easy for such a person to advertise their desires by means of a physical marker, since this can create a social stigma and could actually be off-putting to potential partners.

It is similarly the case that a person could be interested in finding a new tennis partner. Again, the person might well routinely pass many suitable partners, unaware of their suitability. Although discretion is less important when trying to find a partner to meet a need such as this, the person would still find it difficult to make his or her desire for a tennis partner known to suitable people.

Although recent advances in the Internet have provided a wealth of opportunities for people to share information, these all suffer from serious inherent difficulties when serving as a means for users to meet new people, particularly where this is for romantic needs. For example, Internet chat rooms provide a forum in which people can converse freely, unhindered by the usual inhibitions of normal face-to-face contact. This can alleviate the problems associated with the natural coyness of some users, when it comes to discussing romantic issues with strangers, for example. However, a consequence of the lack of face-to-face interaction is that a user has little or no way of verifying the information communicated to them by other users. Also, for a user to arrange a meeting with another user, both users will almost inevitably have to divulge personal information, which could include physical characteristics and contact details. This need to divulge personal information has serious security drawbacks, as revealing even modest personal details over the Internet can lead to dangerous and unwanted attention.

Similarly, there has been huge recent growth in personal mobile communications technology, especially with the escalation in popularity of mobile telephones. However, these devices are also largely unsuitable for meeting new people with shared interests, and are more suited to facilitating communication between users already acquainted with each other.

There therefore remains a need for a means to enable users to find, and if desired, meet others who share the same interests as them, without divulging their personal details to the world at large.

There is also a need for businesses to find new avenues to alert potential consumers of their products or services. Potential customers are continually bombarded with advertisements, often with little or no targeting.

To overcome some of the foregoing problems, WO 97/49192 discloses a portable electronic device for facilitating communications between users possessing compatible devices. The device incorporates a keypad and uses radio signals to communicate with other such devices. A user selects their requirements via the keypad, and communication is established with those devices whose users have made the same key selection. The keys of the device are set to pre-determined functions, which can be changed by the use of plug-in cards and interchangeable masks on the keypad.

Conventional communications devices such as those described in WO 97/49192 provide means for facilitating the meeting of users with shared interests (i.e. those who have selected the same key pattern). However, systems of this type rely on each user being aware of the meaning corresponding to each key selection. Furthermore, although the keypads may be changeable, such devices are not configurable to the precise needs of the user, as they are inherently reliant on a predetermined and finite list of options.

Other conventional communications devices for matching the interests of users, such as those described in WO 00/22860, rely on the use of a central database to store information relating to the needs of the user. In such systems, each user carries a mobile electronic device that relays positional data of the user through a wireless connection to a base station, and on to a central database, which registers information relating to the position of each user. The user is then automatically notified of the proximity of other users whose interests match theirs.

When two users are proximate each other, the central database is checked to see if their stored profiles match and if a match is detected, the users are alerted. Such systems have the drawback that they are inherently reliant on a large infrastructure comprising a network of base stations and a central database. They are also reliant on the wireless technology used by the portable devices being capable of relaying the user's positional data.

It is an object of the present invention to provide a communications device and associated communications method that obviates many of the problems associated with conventional devices for matching the interests of users with compatible devices.

According to a first aspect of the invention there is provided a communications device comprising: a memory adapted to store at least one profile of a user of the device, wherein the said at least one profile contains predetermined attributes and requirements of the user; a transceiver adapted to transmit information relating to the said requirements to a compatible device and receive information relating to requirements of the said compatible device; a controller adapted to register a match between the said device and the said compatible device, only when the said attributes match the said requirements of the said compatible device; and a user alert adapted to alert a user when the controller has established that a match has been made; wherein the said device does not need to receive information relating to attributes of the said compatible device, in order to register a match with the said compatible device.

Such a device is thus adapted to ensure that the user of both the device and the compatible device match each other before either user is alerted. The device is adapted to register a match relying only on the exchange of requirements of the users, and not the attributes. No artificial intelligence is required to match the users, as matches are determined by comparing received requirements with stored attributes. This contrasts to conventional systems, which generally attempt to match users based on what each user has told the system about him or herself.

In a particularly preferred embodiment the user alert is adapted to alert the user only when the controller has established that a match has been made and that a match signal has been received from the compatible device, said match signal indicating that the compatible device has registered a corresponding match.

Preferably the device may comprise a display. The display may be adapted to display an indication of the or each profile stored in the device.

In a preferred embodiment the device is adapted to allow the user to designate which of the stored at least one profiles the user designates as active; the said memory is further adapted to store an indication of the active profile or profiles; and the communicator is further adapted to exchange information with a compatible device based only on the active profile or profiles. The device may comprise a keypad, said keypad being adapted to allow a user to activate a profile from those stored in the device. In a preferred embodiment the display is further adapted to display an indication of the active profiles. The memory may comprise a combination of volatile and non-volatile memory.

The user alert may be adapted to provide a visual indication to the user. In a preferred embodiment the user alert is adapted to provide the visual indication using the display. The user alert may comprise at least one LED. The user alert may be adapted to provide an audible indication to the user. The user alert may be adapted to provide a vibrating indication to the user.

In a preferred embodiment the or each said profile comprises a self-describing data file, each self-describing data file comprising at least one field. The or each said profile may comprise at least one of a plurality of possible field types. The or each said profile can comprise one or more sets of fields of a keyword type, said one or more sets of fields allowing matching to be performed against user determined free text. The or each said profile may comprise a field that can contain a mandatory flag, the said mandatory flag indicating to the device whether blank fields are required to always or never be matched against. In a preferred embodiment, the memory is adapted to store multiple instances of the same profile type; wherein the device is adapted to: match all the multiple instances of the same profile in a matching process that involves transmitting a two dimensional matrix of flags that indicate a match or no match, the columns of said matrix being indexed on the instances of the profile stored in the memory; receive a corresponding two dimensional matrix from the compatible device; transform the received matrix; and compare the transformed received matrix with the sent matrix to identify any and all matches for this profile type.

The or each said profile may comprise a header section, the header section comprising a unique profile ID of the respective profile. In a preferred embodiment the header section is the only section of the or each said profile that cannot be modified by the user.

In a particularly preferred embodiment the attributes and requirements of the or each said profile are determined by the user.

Preferably the device is adapted to communicate with a suitably programmed computer. The device may be adapted to communicate with the suitably programmed computer using a cable connection between the device and the suitably programmed computer. The device may be adapted to communicate with the suitably programmed computer using the said transceiver. In a preferred embodiment the device is adapted to store the populated at least one profile, upon receipt of information relating to the said attributes and requirements from the said computer. The device may be adapted to store new profile types, upon receipt of information relating to the said new profile types from the said suitably programmed computer. The said information relating to the said new profile types may be downloaded to the said suitably programmed computer from any of the Internet, an email attachment, or a MMS attachment.

The device may comprise a timer and a timing register, and wherein the timing register is adapted to store timing information for the or each said profile. Preferably the timing information comprises a predetermined active period for the or each said profile. The timing information may comprise a schedule relating to the activation and deactivation of the or each said profile at user defined times.

In a particularly preferred embodiment the memory is adapted to store a unique ID of the device. The memory may comprise a recent encounters cache, the said recent encounters cache comprising a list of received unique IDs of compatible devices that have communicated with the device. The device may be further adapted to allow the user to blacklist compatible devices after the establishment of a match, and wherein the memory comprises a blacklist cache, the said blacklist cache comprising a list of received unique IDs of compatible devices that the user has blacklisted.

In a preferred embodiment the device comprises a probe alert, the said probe alert being adapted to aid the user physically to locate the user of the compatible device once a match has been established. The probe alert may be adapted to provide a visual location indication to the user. The probe alert may comprise at least one LED. The probe alert may be adapted to provide the visual location indication to the user using the display. The probe alert may adapted to provide an audible location indication. The probe alert may be adapted to provide a vibrating location indication.

In a preferred embodiment the device is adapted to store at least one handle, the or each said handle generally comprising a string of characters, and wherein the device is adapted to enable the or each said handle to be sent to the compatible device on the establishment of a match. The or each said handle may comprise information pertaining to the established match. The memory may be adapted to store a match log, the said match log comprising information regarding previously established matches. In a particularly preferred embodiment the match log may comprise a unique ID of each previously matched compatible device along with any received handles. The match log may comprise information regarding details of communications between the device and compatible devices that did not result in a match. The device may be adapted to upload the contents of the match log to the suitably programmed computer.

In a preferred embodiment the memory is adapted to store only profiles that comprise a predetermined flag in the header section. Preferably the predetermined flag is formed from a number of bits of the Profile ID, and the device adapted only to match with compatible devices that have at least one stored profile with an identical corresponding bit set of the predetermined flag.

In a particularly preferred embodiment the transceiver is adapted to exchange information with the compatible device using short range wireless communications. The short range wireless communications may employ radio or microwave transmission. The wireless communication may employ Bluetooth or Wi-Fi transmission. The wireless communication may employ any location aware telecommunications network. The location aware telecommunications network may employ 3G transmission.

The transceiver may be adapted to exchange information with the compatible device using long range wireless communications.

The device may be a portable device. The portable device may be any one of, or a combination of: a mobile telephone, a PDA, a pager, a palmtop computer, a notebook computer or a laptop computer. The device may be adapted to perform any one of, or a combination of: populating the or, each said profile, creating new profiles, connecting to the Internet or accessing email or MMS attachments and downloading new profiles.

The device may not be portable. The device may be any of: a personal computer, workstation, server, or terminal. The device may be adapted to perform any one of, or a combination of: populating the or each said profile, creating new profiles, connecting to the Internet or accessing email or MMS attachments and downloading new profiles.

In a preferred embodiment the memory is adapted to store at least one profile that is a symmetric profile, the said symmetric profile comprising a set of attributes and requirements fields which is adapted to be symmetric with respect to that of a compatible device.

In a preferred embodiment the memory is adapted to store at least one profile that is an asymmetric profile, the said asymmetric profile comprising a set of attributes and requirements fields that is adapted to be asymmetric with respect to that of a compatible device. The device may be adapted to store an indication of whether the user is a provider or a finder in the profile. The said asymmetric profile may comprise multiple instances of the attributes of the user. The device may be adapted to populate the attributes of the said asymmetric profile by referencing an external database, the said external database being stored on any of a LAN, a WAN, personal computer, workstation, server, terminal or the Internet. The device may be adapted to store the results of the reference to the external database after a match has been established, if the user of the compatible device becomes out of range before the user of the device is alerted to the match; and alert the user to the match if the user of the compatible device becomes in range again within a predetermined time period, without referring to the external database again.

In an embodiment the device is adapted to upload the or each said profile to a central database, said central database being adapted to store location information relating to the users; and match users based on the attributes and requirements of the or each said profile and the location information relating to the users.

According to a second aspect of the invention there is provided a communications method comprising the steps of: storing at least one profile of a user in a memory of a communications device, wherein the or each said profile contains predetermined attributes and requirements of the user; using a transceiver of the device to transmit information relating to the said requirements to a compatible device and receive information relating to requirements of the said compatible device; using a controller to register a match between the said device and the said compatible device, only when the said attributes match the said requirements of the said compatible device; and using a user alert to alert a user when the controller has established that a match has been made; wherein the said device does not need to receive information relating to attributes of the said compatible device, in order to register a match with the said compatible device.

In a particularly preferred embodiment the user is alerted only when a match has been registered and a match signal has been received from the compatible device, the said match signal indicating that the compatible device has registered a corresponding match.

Preferably the method further comprises the step of using a display to display an indication of the profiles stored in the device.

In a preferred embodiment the method further comprises the steps of allowing the user to designate which of the stored at least one profiles are designated as active; storing an indication of the active profile or profiles in the memory; and exchanging information with a compatible device based only on the active profile or profiles. The method may comprise the step of using a keypad to activate a profile from those stored in the device. The method may comprise the step of using the display to display an indication of the active profile or profiles. The memory may comprise a combination of volatile and non-volatile memory.

The method may comprise the step of using the user alert to provide a visual indication to the user. In a preferred embodiment the visual indication may be provided using the display. The visual indication may be provided using at least one LED. The method may comprise the step of using the user alert to provide an audible indication to the user. The method may comprise the step of using the user alert to provide a vibrating indication to the user.

In a preferred embodiment the or each said profile comprises a self-describing data file, each self-describing data file comprising at least one field. The or each said profile may comprise at least one of a plurality of possible field types. The or each said profile may comprise one or more sets of fields of a keyword type, said one or more sets of fields allowing matching to be performed against user determined free text. The or each said profile may comprise a field that can contain a mandatory flag, the said mandatory flag indicating to the device whether blank fields are required to always or never be matched against. In a preferred embodiment, the method may further comprise the steps of storing multiple instances of the same profile type in the memory; matching all the multiple instances of the same profile in a matching process that involves transmitting a two dimensional matrix of flags that indicate a match or no match, the columns of said matrix being indexed on the instances of the profile stored in the memory; receiving a corresponding two dimensional matrix from the compatible device; transforming the received matrix; and comparing the transformed received matrix with the sent matrix to identify any and all matches for this profile type.

The or each said profile may comprise a header section, the header section comprising a unique profile ID of the respective profile. In a preferred embodiment the header section is the only section of the or each said profile that cannot be modified by the user.

In a particularly preferred embodiment the user determines the attributes and requirements of the at least one profile.

Preferably the device communicates with a suitably programmed computer. The device may communicate with the suitably programmed computer using a cable connection between the device and the suitably programmed computer. The device may communicate with the suitably programmed computer using the said transceiver. In a preferred embodiment the device stores the populated profile, upon receipt of information relating to the said attributes and requirements from the said computer. The device may store new profile types, upon receipt of information relating to said new profile types from said suitably programmed computer. The said information relating to the said new profile types may be downloaded to said suitably programmed computer from the Internet, or via an email attachment or MMS attachment.

The method may comprise the step of storing timing information for the or each said profile in a timing register. Preferably the timing information comprises a predetermined active period for the or each said profile. The timing information may comprise a schedule relating to the activation and deactivation of the or each said profile at user defined times.

In a particularly preferred embodiment the device stores a unique ID of the device. The memory may comprise a recent encounters cache, the said recent encounters cache comprising a list of received unique IDs of compatible devices that have communicated with the device. In a preferred embodiment the user can optionally blacklist compatible devices after the establishment of a match, and wherein the memory comprises a blacklist cache, the said blacklist cache comprising a list of received unique IDs of compatible devices that the user has blacklisted.

In a preferred embodiment the method comprises the step of using a probe alert to aid the user to physically locate the user of the compatible device once a match has been established. The said probe alert may provide a visual location indication to the user. The probe alert may comprise at least one LED. The probe alert may use the display to provide the visual location to the user. The probe alert may provide an audible location indication to the user. The probe alert may provide a vibrating location indication.

In a preferred embodiment at least one handle is stored in the device, the or each said handle generally comprising a string of characters, and wherein the device sends the or each said handle to the compatible device on the establishment of a match. The or each said handle may comprise information pertaining to the established match. A match log may be stored in the memory, the said match log comprising information regarding previously established matches. The match log may comprise a unique ID of each previously matched compatible device along with any received handles. The match log may comprise information regarding details of communications between the device and compatible devices that did not result in a match. The device may upload the contents of the match log to the suitably programmed computer.

In a preferred embodiment only profiles that comprise a predetermined flag in the header section are stored in the memory. Preferably, the predetermined flag may be formed from a number of bits of the Profile ID, and wherein the device only attempts to match with compatible devices that have at least one stored profile with an identical corresponding bit set of the predetermined flag.

In a particularly preferred embodiment the transceiver exchanges information with the compatible device using short range wireless communications. The short range wireless communications may employ radio or microwave transmission. The wireless communications may employ Bluetooth or Wi-Fi transmission. The wireless communication may employ any location aware telecommunications network. The location aware telecommunications network may employ 3G transmission.

The transceiver may exchange information with the compatible device using long range wireless communications.

The device may be a portable device. The portable device may be any one of or a combination of: a mobile telephone, a PDA, a pager, a palmtop computer, a notebook computer or a laptop computer. The method may comprise the steps of using the portable integrated device to perform any one of, or a combination of: populating the or each said profile, creating new profiles, connecting to the Internet or accessing email or MMS attachments and downloading new profiles.

The device may not be portable. The device may be any of: a personal computer, workstation, server, or terminal. The device may perform any one of, or a combination of: populating the or each said profile, creating new profiles, connecting to the Internet or accessing email or MMS attachments and downloading new profiles.

In a preferred embodiment the method comprises the steps of using at least one profile that is a symmetric profile stored in the memory, the said symmetric profile comprising a set of attributes and requirements fields which is adapted to be symmetric with respect to that of a compatible device.

In a preferred embodiment the method comprises the steps of using at least one profile that is an asymmetric profile stored in the memory, the said asymmetric profile comprising a set of attributes and requirements fields that is adapted to be asymmetric with respect to that of a compatible device. The device may be adapted to store an indication of whether the user is a provider or a finder in the profile. In a particularly preferred embodiment the said asymmetric profile comprises multiple instances of the attributes of the user. The device may populate the attributes of the said asymmetric profile by referencing an external database, the said external database being stored on any of a LAN, a WAN, personal computer, workstation, server, terminal or the Internet.

The method may further comprise the steps of: storing the results of the reference to the external database after a match has been established, if the user of the compatible device becomes out of range before the user of the device is alerted to the match; and alerting the user to the match if the user of the compatible device becomes in range again within a predetermined time period, without referring to the external database again.

In an embodiment, the method may further comprise the steps of: uploading the or each said profile to a central database, said central database being adapted to store location information relating to the users; and matching users based on the attributes and requirements of the or each said profile and the location information relating to the users.

According to a third aspect of the invention there is provided a communications system comprising at least two communication devices using symmetric profiles, wherein the controller of each device is respectively adapted to register a match between the device and the other device based on the symmetric profile, wherein the system is adapted to treat the attributes and requirements of each respective user equally.

According to a fourth aspect of the invention there is provided a communications system comprising at least two communication devices using asymmetric profiles, wherein the controller of each device is respectively adapted to register a match between the device and the other device based on the asymmetric profile, wherein the system is adapted to treat the attributes and requirements of each respective user differently.

The present invention provides a device and method for matching users whose respective user's stored requirements and attributes match. The matching process provides discretion for the user, as users are only alerted when a two-way match has been established. Furthermore, the matching process does not reveal the personal details of the user, as only the requirements of the user are sent from the device. The matching process is also entirely based on the matching of the respective users' attributes and requirements, and no artificial intelligence is required. Such devices obviate many of the problems associated with conventional devices.

For a better understanding of the invention, several embodiments of a communications device and method of communication in accordance with the invention will now be described with reference to the accompanying drawings in which:

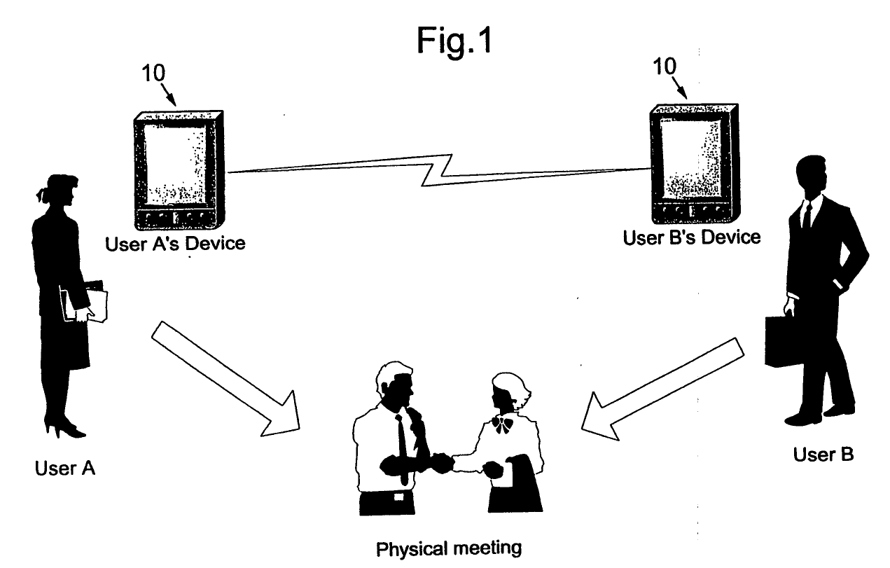

FIG. 1 is a schematic diagram of an embodiment of a communications system according to the present invention;

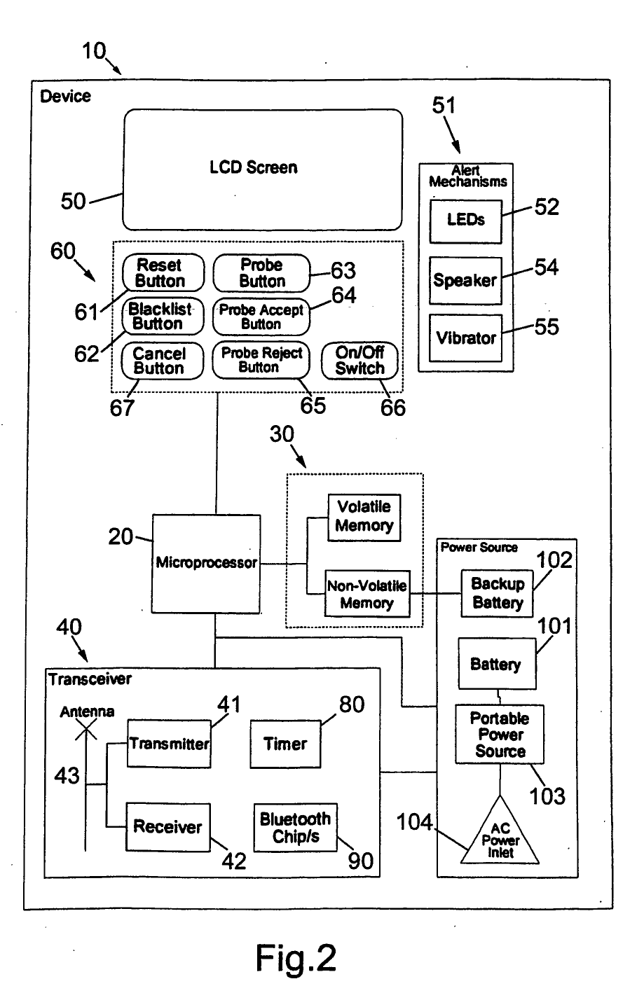

FIG. 2 is a schematic diagram of an embodiment of a communications device according the invention;

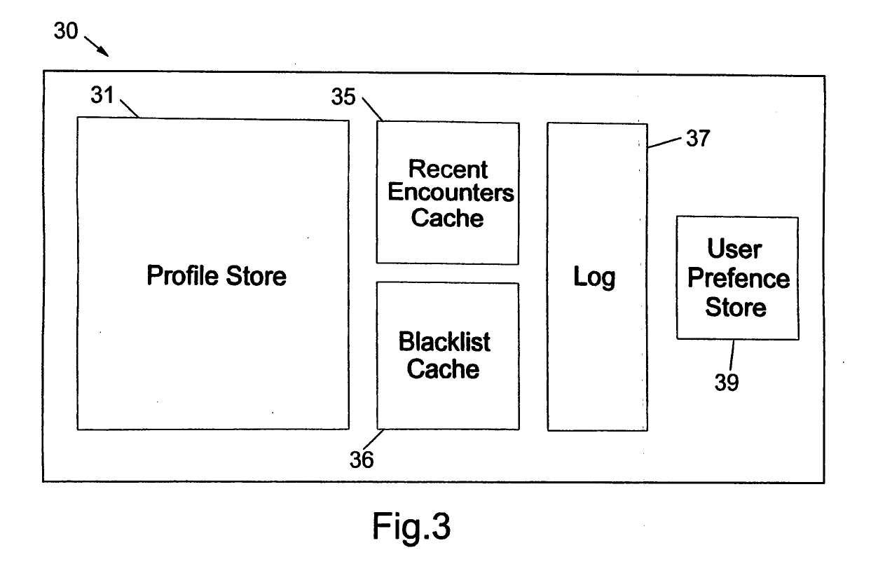

FIG. 3 is a schematic diagram of the memory structure of the communications device of FIG. 2;

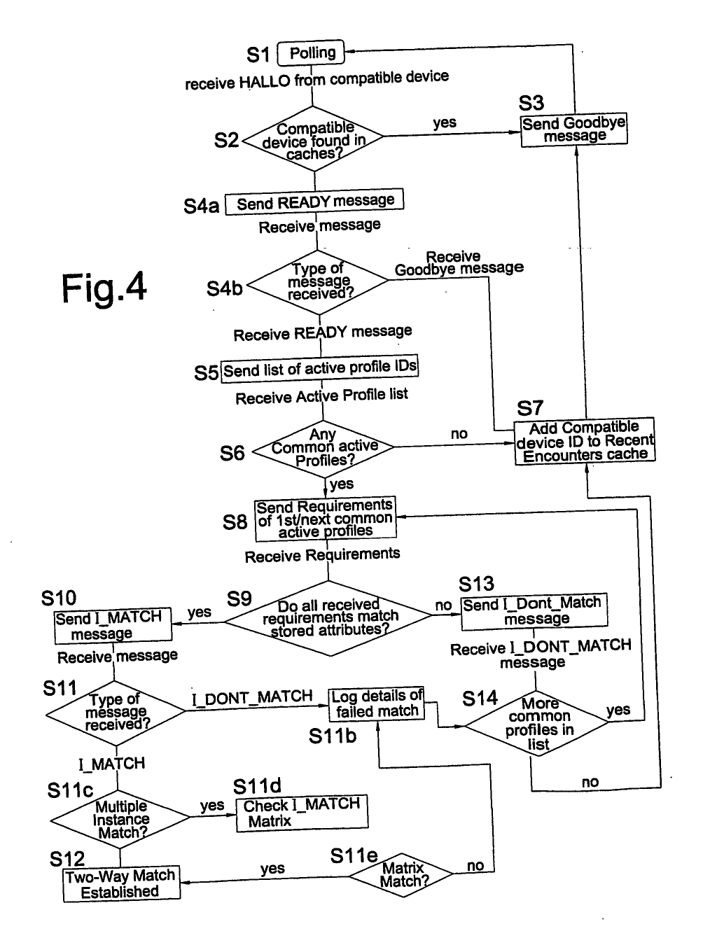

FIG. 4 is a flow diagram illustrating a method of obtaining a two-way match between two devices according to the invention;

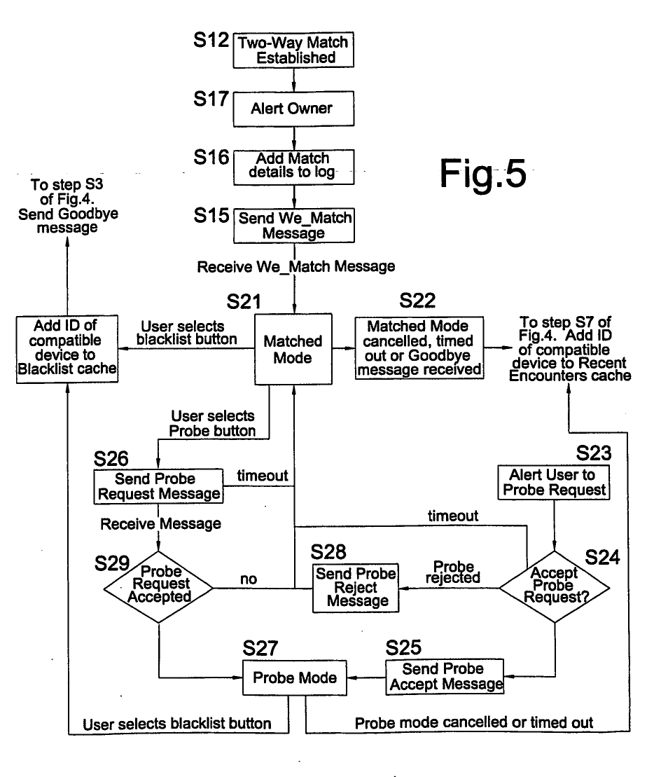

FIG. 5 is a flow diagram illustrating processes that occur after a two-way match has been obtained between two devices in accordance with the invention;

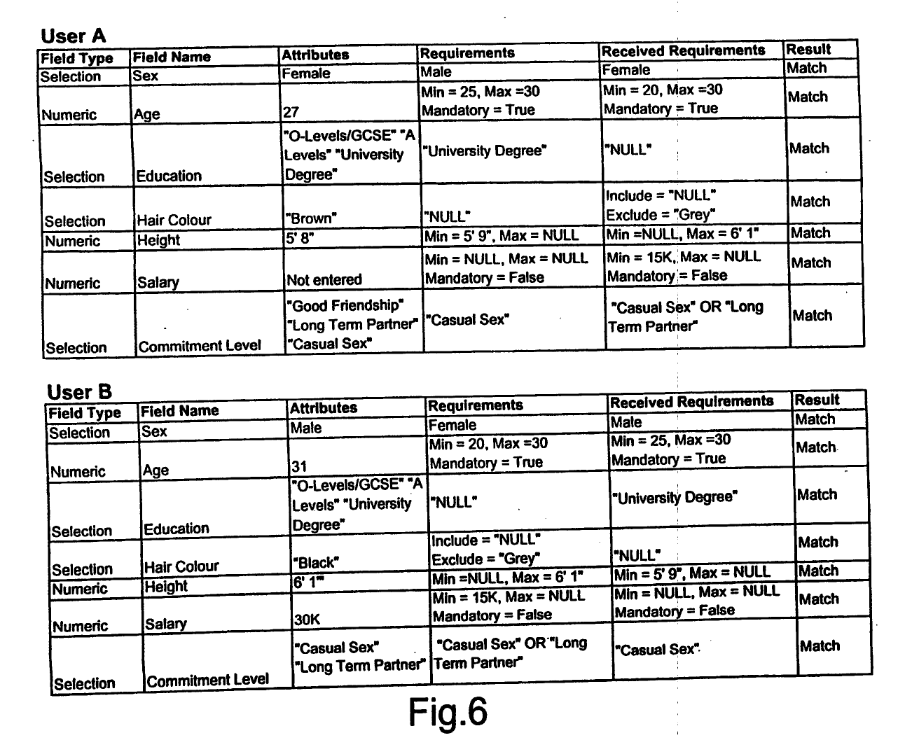

FIG. 6 is a table showing an example of an abbreviated user profile suitable for use in an embodiment of the invention;

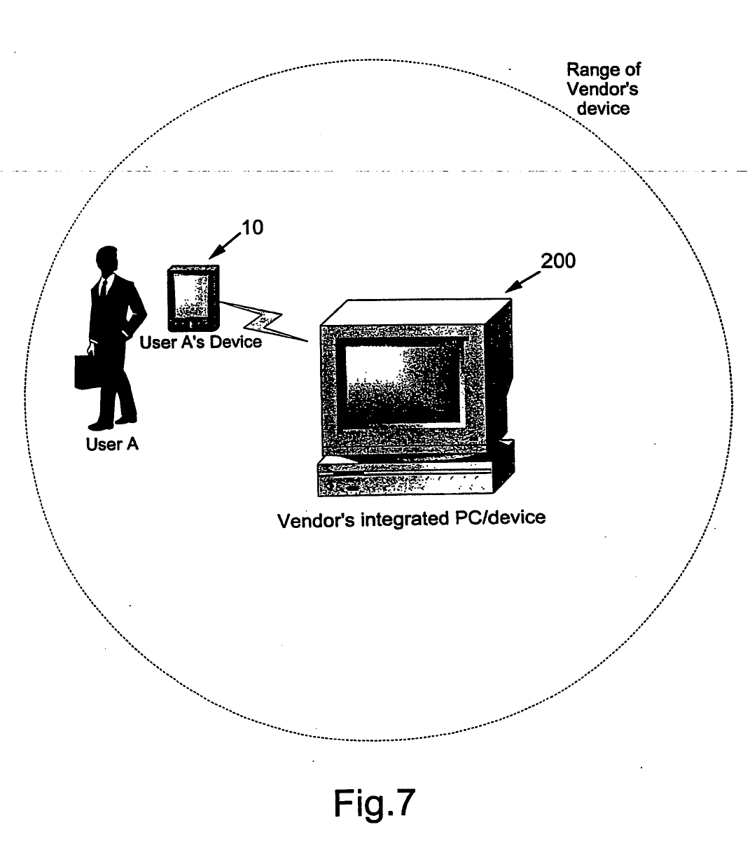

FIG. 7 is a schematic diagram of a further embodiment of a communications system according to the invention; and

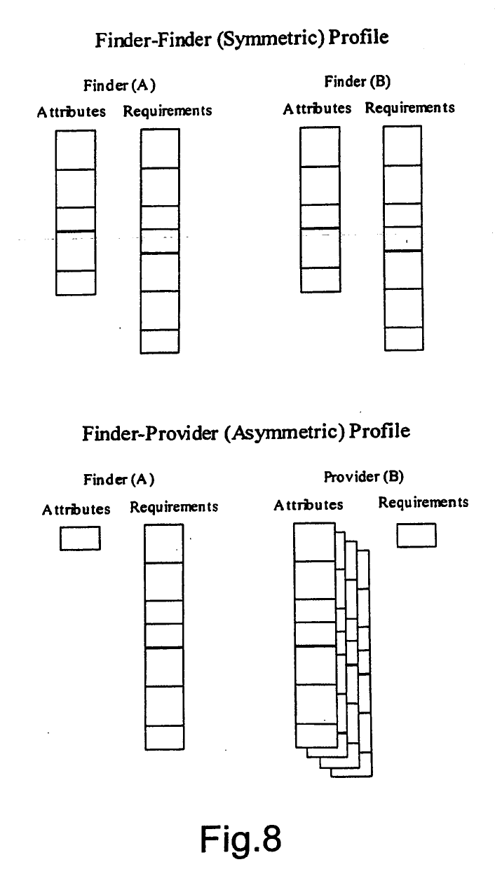

FIG. 8 is an illustration comparing the size and shape of the attributes and requirements of two users using symmetric profiles with two users of asymmetric profiles.

FIG. 1 schematically illustrates interaction between two users, denoted User A and User B, each carrying a portable electronic device 10. Although devices 10 are shown as application-specific portable devices, in FIG. 1, this need not be the case. Each device 10 could be integrated into any existing portable device such as a mobile telephone, PDA, pager, or portable computer, such as a palmtop, notebook, or laptop. Although FIG. 1 illustrates communication between two substantially similar devices, the invention is not limited in this way, and an application-specific version of the device 10 could be capable of communicating with, for example, a compatible device integrated with a mobile telephone, or even a compatible stationary unit such as a desktop computer

FIG. 2 schematically illustrates an application-specific portable device 10 provided with a LCD screen 50, a keypad 60, an alert means 51, memory 30, power source 100, and a transceiver 40 respectively connected to a processor 20. Other embodiments could employ alternative display means. The keypad 60, comprises a reset button 61, a blacklist button 62, a probe button 63, a probe accept button 64, a probe reject button 65, and an on/off switch 66. Other embodiments may provide additional buttons allocated to additional functions, or employ alternative user input means. The alert means 51 comprises a set of LEDs 52, a speaker 54 and a vibrator 55. Other embodiments may employ alternative alert means.

The power source 100 provides power to the device 10, and comprises a battery 101, backup battery 102, portable power source 103 and an AC power inlet 104. The combination of the battery 101 and backup battery 102 provide a means for storing power from the portable power source 103. The AC power inlet 104 provides a means for re-charging the portable device 10. Other embodiments may employ alternative means of storing and supplying power to the device 10.

The transceiver 40 comprises a transmitter 41 and a receiver 42, respectively connected to an antenna 43, Bluetooth chips 90 and a timer 80. The combination of the transmitter 41, receiver 42 and antenna 43 use short range wireless communication technology to communicate with compatible devices within range. There are few restraints on the type of wireless communications technology which can be used with the invention, for example radio or microwave transmissions could be used. Although it will be apparent that using short range communications has significant advantages in some embodiments of the invention, other embodiments could employ long range communications technology. The embodiment illustrated in FIG. 2 uses Bluetooth technology to enable communication between devices. Although the communications flow described later is effectively peer-to-peer, the communications protocol on which it is built may require that it be implemented within an underlying master-slave paradigm.

The device 10 stores information comprising the attributes of the user, and the requirements of the user in one or more profiles, which are stored in the memory 30. The memory 30 could comprise any conventional volatile or non-volatile memory, or preferably a combination of the two. FIG. 3 is a schematic diagram of the structure of memory of the device 10. The memory 30 comprises a profile store 31, a recent encounters cache 35, a blacklist cache 36, a log 37, and a user preference store 39. Other embodiments of the invention could be provided with an alternative memory configuration.

The user's attributes and requirements for each of the one or more profiles are stored in the profile store 31 of the memory 30. A “profile” is a self-describing data file that is made up of a series of fields. Once populated by the user, a profile contains the data that allows the device 10 to carry out a meaningful search. The device 10 could store one or more profiles, including multiple instances of the same profile type, which are populated with different criteria, to allow the device to try and match the user based on a number of different sets of criteria.

The “attributes” are personal data of the user and contain a set of characteristics of the user or something offered by the user. The attributes for a given profile are stored in the attributes section of the profile. The “requirements” are the user's search criteria, and define which attributes relating to other users of compatible devices the user of the device 10 is seeking. The requirements are stored in the requirements section of the profile.

In the embodiment illustrated in FIG. 2, the user selects and configures the profiles to be stored in the device 10 using a personal computer (PC). For each type of profile selected, the user enters their attributes and requirements on the PC via a suitable graphical interface. Once the selected profile has been populated with the relevant data, the user uploads the profile to their device 10, where it is stored in the profile store 31 of the memory 30. The user can upload more than one profile to the device, including multiple instances of the same profile type. For example, a user may wish to find both a tennis partner and a squash partner at the same time. This user may well have different attributes and requirements for the two sports, as their proficiency level may differ greatly between the two.

The following are examples of profiles suitable for use with this embodiment of the invention:

Relationship Finder Profile: the object of this profile is to aid a user to find a personal relationship. A user enters their personal details, which are stored in the fields of the attributes section. The user also enters the search criteria in the fields of the requirements section. The requirements section will contain fields including one that defines a desired level of commitment. This can range from casual sex, to friendship, to marriage and children. The user may also enter information within a text field of a handle section of the profile. This handle information may be transmitted when a two-way match is established for this profile.

Sports Partner Finder Profile: the object of this profile is to aid a user in finding a suitable sports partner. A user enters the relevant details about themselves in the attributes section, together with the appropriate search criteria for finding others in the requirements section. The requirements section contains information such as the particular sport, how often and when the user would like to play, the user's competency level, etc.

The device 10 connects to the PC via the transmitter 41, using the short range communications capability of the device 10. Such an embodiment relies on the PC being suitably equipped to receive short range communications sent by the device. In other embodiments of the invention, the connection between the device 10 and a PC could be established by way of a physical connection, which would require the device 10 comprising a suitable PC interface.

In order to select and configure the profiles for use on the device 10, the PC is provided with suitable editing and uploading software. This software could be supplied with the device 10, and comprise a set of officially endorsed profiles. Alternatively, the user may use the PC to connect to the Internet, and download new profiles from a suitable web server. Alternatively profiles could be downloaded from an email or MMS attachment. These downloaded profiles could be officially endorsed by the suppliers of the device 10, or created by third parties.

Although the populating and editing of profiles has been discussed with reference to the use of a PC with access to the Internet, the invention is not limited in this way. A laptop computer, workstation, server, office terminal or PDA could all be suitable for editing and uploading profiles to the device 10. Furthermore, in embodiments which are integrated into other devices, such as mobile telephones or PDAs, the downloading and editing of the profiles could be performed using the integrated device alone. In such embodiments, the use of the transceiver 40 or suitable PC interface to connect to a PC would not be required, but may be optionally desired. It would also be possible to configure even an application specific embodiment of the device to accept a removable data carrier, such as a solid state, optical or magnetic storage media, upon which could be pre-loaded a selection of profiles.

An indication of the profiles stored in the memory 30 of the device 10 is displayed on the LCD screen 50. The user uses the keypad 60 to select one or more profiles that they wish to be made active from those displayed. Once active, the name of the profile may be displayed on the LCD screen 50. Activating a profile indicates to the processor 20 to commence the process of trying to obtain a match. The process of trying to obtain a match will be discussed in more detail in relation to FIG. 4.

Each device 10 has a unique Identification Number (ID) that cannot be altered by the user, and is stored in the memory 30. Optionally, the user can enter a “handle” for each profile, which is stored in the handle section of the profile. The handle section of a profile comprises at least one field, and a handle may comprise a string of characters and could take the form of a name or nickname, or details about a match between two users. If present, the handle is transmitted by the device 10 to users of compatible devices on the establishment of a match. The handle is stored in the memory 30, and could be entered via the keypad 60 or edited on the PC and uploaded to the device 10. If a handle is entered by the user, its transmission to other users is optional, and could be turned off by the user using the keypad 60 at any time.

If the user carries or wears the device 10, containing active profiles, the device 10 actively and unobtrusively attempts to seek out matches with compatible devices using the short range communications capability of the device 10.

The user can change the profiles that are currently active to suit their immediate needs by use of the keypad 60. For example, a user who has previously activated the Relationship Finder Profile may wish to disable this profile while they at work. Similarly, a user who activated the Sports Partner Finder Profile may wish to deactivate this profile once a suitable partner has been found.

Every profile is subject to a predetermined active period, and the device 10 comprises a timer 80 that instructs the processor 20 to deactivate every profile after the predetermined period has elapsed. This prevents outdated profiles from being kept active. The predetermined period for each profile can be edited on the keypad 60 of the device 10, or on the PC prior to uploading the profile to the device.

In order to further facilitate the activating and deactivating of profiles, the user can also set the timer 80 to instruct the controller 20 to activate or deactivate stored profiles at predetermined times of the day or week. This could allow the user to set up a profile diary to suit their needs, and could give the user the capability of automating the selection of active profiles. The predetermined times of the day or week could be edited on the keypad 60 of the device 10, or on the PC prior to uploading the profile to the device 10. These timed settings are stored in the profile and could be overridden at any time by the user, for example by using the keypad 60.

When the device 10 establishes a match with a compatible device, the device 10 enters matched mode and alerts the user to the match. The user could be alerted to the match by any user-determined combination of one or more flashing LEDs 52, a message on the display 50, an audible alert or a vibrating alert. These and other user preferences are stored in the User Preferences Store 39 of the memory 30.

If selected, the audible alert is provided by the speaker 54, and could take the form of a ring tone or similar alert. The vibrating motion is provided by the vibrator 55, which is of a conventional sort, such as those common in mobile telephones. The user selects their alert preference, which could depend on their current situation, by means of the keypad 60. For example, on a crowded train a user might prefer to select a silent, vibration-only alert. The user of the compatible device is similarly alerted to the match, at substantially the same time as the first user.

Once a match has been established, the user's optional handle is transmitted to the compatible device with which a match has been established, if desired by the user. In the ensuing matched mode, information regarding the match, though not the personal details that comprise the attributes of the user of the compatible device (which have never been transmitted), is displayed on the LCD screen 50. This match information can be optionally stored in the log 37 of the memory 30 of the device 10 for later review on the device 10. Optionally it could be uploaded to the user's PC, where the data could be analysed.

The method by which the device 10 obtains a match with a compatible device will now be described in detail with reference to FIG. 4. Prior to step S1, the user selects and activates one or more profiles stored in the memory 30 of the device 10, in the manner such as that detailed above.

In the following description it is assumed that the steps represented in FIGS. 4 and 5 are performed by both the device 10 and the compatible device during the course of the dialogue.

At step S1 the device 10 is in a state in which it is polling for other compatible devices. The controller 20, in conjunction with the timer 80, instructs the transmitter 41 to send a “HALLO” message at predetermined frequent intervals. A HALLO message is a short message string that contains information about the device it was sent from, and includes the unique ID number of the device 10. The unique ID of the device 10 is included in every message that it transmits. This enables the device 10 and the compatible device to maintain exclusive dialogue with each other, even if other such devices are in range. During the polling state the receiver 42 is continually operable to detect any HALLO messages sent from compatible devices in range. Polling represents the base state of the device 10, and the device returns to polling if any stage in the processes detailed in FIG. 4 or 5 times-out. This could be due to a communications disruption or the compatible device moving out of range. The device 10 also returns to polling if the user resets the device 10 at any point, for example by means of the reset button 61 on the keypad.

If the receiver 42 receives a HALLO message from a compatible device during polling, it will instruct the processor 20 to enter into an exclusive dialogue with the compatible device that sent it. The received HALLO message will contain the ID of the compatible device, which the processor 20 compares, at S2, with the received ID of the compatible devices stored in the Recent Encounters Cache 35 and the Blacklist Cache 36 of the memory 30.

The Recent Encounters Cache 35 comprises a list of IDs of compatible devices that the device 10 has communicated with recently. The purpose of this cache is to prevent the device 10 from repeatedly attempting to establish a match with the same compatible device. This could prevent, for example, the devices of two people in the same train carriage from continually entering into exclusive dialogue with each other. The presence of the Recent Encounters Cache also ensures that where many compatible devices are in range of each other, every device 10 will attempt to match with every other compatible device. The Recent Encounters Cache 35 comprises the most recently encountered IDs of compatible devices. When the Recent Encounters Cache 35 becomes full, the oldest entry will be purged. Entries in the Recent Encounters Cache 35 could also be purged after a predetermined time has elapsed. Furthermore, the user could purge the Recent Encounters Cache 35 manually.

The Blacklist Cache 36 contains a list of the IDs of compatible devices that the user of the device 10 has blacklisted after a match has been established. The contents of the Blacklist Cache 36 could be purged in the same way as for the Recent Encounters Cache 35 described above.

If the received HALLO message contains an ID of a device found in either cache, the device 10 proceeds to step S3, where the device breaks off the exclusive dialogue with the compatible device, and sends a “GOODBYE” message to the compatible device. The device 10 then proceeds back to step S1, where it resumes polling. The GOODBYE message informs the compatible device that the exclusive dialogue has been broken off, and not to expect further communications.

If the received HALLO message contains an ID of a device that is not found in either cache, the device 10 sends a “READY” message to the compatible device at step S4a. The READY message informs the compatible device that its HALLO message has been received, and that the device 10 has not found the ID of the compatible device in its caches.

At step S4b, the device 10 will have received a message from the compatible device. If the compatible device found the device ID in its caches at step S2, then the device will have a received a GOODBYE message. This will result in the device 10 proceeding to step S7.

If the ID of the device 10 was not found in either cache of the compatible device, the device 10 will have received a READY message. Both devices will now be in a ready state, and the device 10 proceeds to S5.

At S5 the device 10 and the compatible device have established an exclusive dialogue. Both devices then send an Active Profile list to the other device. The Active Profile list comprises a sorted list of those profiles currently active. The profiles could be sorted in any way, as long as it was consistent for compatible devices.

At S6, the processor 20 compares the Active Profile lists of both devices and generates a sorted list containing any active profiles that the device 10 and the compatible device have in common. If no common active profiles are detected, the processor 20 adds the ID of the compatible device to the Recent Encounters Cache 35 at S7, sends a GOODBYE message at S3, and the device 10 returns to polling.

If one or more common active profiles are detected, the device 10 proceeds to S8. The processor 20 selects the first/next profile on the list. The device 10 then sends the user's requirements that are stored in the requirements section of the selected active profile to the compatible device. The compatible device similarly sends the requirements of the selected active profile of its user at substantially the same time. At no point in the matching process does either device send the personal details of the user that are stored in the attribute fields of the active profiles. This means that the security of the system is high, and the most a suitably equipped snooping device could intercept is search criteria in the form of requirements. This information would be addressed by a unique device ID, and could not be easily traced back to the user who created them.

Once the device 10 has received the requirements of the compatible device, they are stored in the memory 30. At S9, the processor 20 compares the received requirements with the fields in the attributes section of the selected active profile, in order to ascertain whether they match.

If all the received requirements match the user's stored attributes then, at S10, the device 10 sends an I_MATCH message to the compatible device. The device 10 then waits for a corresponding message from the compatible device. The device 10 will then either receive an I_MATCH message or an I_DON'T_MATCH message, and proceed to S11.

If an I_MATCH message is received from the compatible device, then the sent requirements of the device 10 match the stored attributes of the compatible device. If neither device has multiple active instances of the selected active profile (S11c), a two-way match has thus been established (S12) for this profile. The more complex case wherein one or both devices have multiple instances of the profile will be discussed later.

If an I_DON'T_MATCH is received, then the sent requirements of the device 10 do not match the stored attributes for any active instances of the profile in the compatible device. The device 10 then logs the details of the failed match at S11b and proceeds to S14.

If, at S9, less than all the received requirements match the stored attributes for each active instance of the profile, the device 10 will send an I_DON'T_MATCH message to the compatible device (S13). Then, regardless of whether the device 10 then goes on to receive an I_MATCH or an I_DON'T_MATCH message, the device 10 proceeds to S14.

At S14 the controller 20 checks if there are any more common active profiles on the sorted list. If there is another common active profile the device 10 returns to step S8, and sends the requirements of the next common active profile from the sorted list. The device 10 then goes through the process of checking if the received requirements match the stored attributes, following the steps detailed above.

If there are no more common active profiles on the list, the device 10 proceeds to step S7, where the ID of the compatible device is added to the Recent Encounters Cache 35, a GOODBYE message is sent (S3), and the device 10 returns to polling.

When either the device 10 or the compatible device has multiple active instances of a particular profile special consideration is required. Multiple active instances of a profile are dealt with as a single matching process. When a device 10 has x active instances of a profile, then at S5 when the device 10 sends its active profile list to the compatible device, that profile will be included in the Active Profile list x times. If the compatible device has y active instances of the same profile, where y is greater or equal to one, then the profile is common to both devices, and at S6 the processor 20 will include the ID of the common profile only once in the common active profile list that it generates.

At S8, when the device 10 reaches this profile in the sorted common profile list, x sets of requirements will be included in the requirements transmission from the device 10 to the compatible device, and y sets of requirements will be included in the requirements transmission from the compatible device to the device.

At S9, the device 10 will compare each set of received requirements against each set of attributes held by the device 10. In the case where no matches are found for this profile in any of its active instances, the device 10 sends an I_DONT_MATCH message at S13. In the case where one or more matches are found for this profile in one or more of its active instances, the device 10 proceeds to S10 and sends an I_MATCH message, comprising a 2-dimensional matrix of match/no_match flags in which the columns are indexed on the instances of the profile held by the device 10. In the case where the compatible device finds one or more matches for this profile type, the compatible device will similarly send an I_MATCH message comprising a matrix, in which the columns of the matrix are indexed on the instances of the profile held by the compatible device. Receipt of this message will cause the device 10 to proceed to S11c via S11. As the received I_MATCH message is of the special form required for multiple active instances of a profile type, the device 10 proceeds to S11d.

At S11d, the device 10 will transform the received matrix so that it can be compared with the matrix built by the device at S9. This comparison will identify any and all two-way matches for this profile type. At S11e, if there are no two-way matches, the device will proceed to S11b and log details of the failed match. If there are any two-way matches, the device 10 and the compatible device will each proceed to S12, and a Two-Way Match has been established.

Once the device 10 has established a two-way match, the device will enter a matched mode. The establishment and operation of this mode will be discussed below in more detail in relation to FIG. 5, however before this, a more detailed example of how the processor 20 processes the data in the selected active profile in order to ascertain whether the profiles of the respective users match will be discussed with reference to FIG. 6. FIG. 6 shows an abbreviated example of two Relationship Finder Profiles, as respectively populated by the user of a device 10 (User A), and a user of a compatible device (User B), as discussed above in relation to FIG. 1.

In this example, User A is a woman seeking a personal relationship and User B is a man similarly seeking such a relationship. Both users possess a device 10, of the kind illustrated in FIG. 2, or a device compatible with such devices.

Prior to the meeting, User A connects her device 10 to her PC, selects a Relationship Finder Profile from the list of profiles stored on her PC, and populates the data according to her attributes and requirements. These data are then uploaded to the profile store 31 of User A's device 10, and the Relationship Finder Profile activated. Prior to the meeting, User B has similarly populated, uploaded, and activated a Relationship Finder Profile.

A profile such as the Relationship Finder Profiles illustrated in FIG. 6 comprises a set of attributes and requirements fields of various predetermined types. The types of data possible in each field, and example field structures will be discussed in more detail later. If and only if every attribute field matches the corresponding received requirement field for a particular profile, will the whole profile result in a match.

As can be seen in FIG. 6, User A is a 27 year old female, who is 5′8″ with brown hair. She has O-levels/GCSEs, A-levels and a University Degree, and has not entered her salary. She would consider being matched with other users who wanted a relationship based upon the commitment level “Good Friendship”, “Long Term Partner” or “Casual Sex”. These data fields comprise information personal to User A, and are stored in the attributes section of User A's Relationship Finder Profile.

User A is interested in meeting a male who must be between 25 and 30, have a University Degree, be no shorter that 5′9″ and must be interested in a relationship with commitment level of “Casual Sex”. These data fields comprise the requirements of user A, and are stored in the requirements section of User A's Relationship Finder Profile.

User B is a 31 year old male, who is 6′1″ with black hair. He has O-levels/GCSEs, A-levels and a University Degree, and a salary of £30K. He would consider being matched with other users who wanted a relationship based upon the commitment level “Long Term Partner” or “Casual Sex”. These data comprise information personal to user B, and are stored in the attributes section of User B's Relationship Finder Profile.

User B is interested in meeting a female who must be between 20 and 30, be no taller than 6′1″, have any colour hair except grey, and must be interested in a relationship with commitment level of “Casual Sex” or “Long Term Partner”. They must also earn a minimum of £15K if they have entered their salary, but as user B set the mandatory flag to equal ‘False’ in the salary field non disclosure of salary will not lead to rejection. These data comprise the requirements of user B, and once entered on user B's PC are uploaded to user B's device 10 and stored in the requirements section of User B's Relationship Finder Profile.

Considering User A's profile, all the received requirements fields from User B match the stored attributes fields. Therefore at step S9 of FIG. 4, the controller 20 of User A's device would instruct the transmitter 41 to send an I_MATCH message to User B's device.

However, User A's device will not enter matched mode unless a two-way match is established. As all User B's attributes fields match the received requirements from User A's device, User B's device will send an I_MATCH message to User A's device. User A and User B will have then both sent and received I_MATCH signals, which will result in a Two-way Match being established (S12), and both devices will enter matched mode.

The steps following the establishment of a two-way match will now be discussed with reference to FIG. 5. On the establishment of a two-way match the device 10 proceeds to alert the user at step 17. All the described matching steps prior to S17 would have been invisible to the user. The user is only alerted once a two-way match has been established. As discussed above, the user alert could take many forms, and in particular could be a combination of an audible alert produced by the speaker 54, a vibrating alert produced by the vibrator 55, and a visual alert on the LCD screen 50.

At S16, the device 10 then adds details of the matched profiles to the Two-Way Match log, located in the log store 37 of the memory 30. This records the details of the match, so that they can be later examined by, for example, uploading the data from the two-way match log to the user's PC. This could include information such as the name of the matched profile and details of the requirements that were sent by the compatible device.

At step S15 the device then proceeds to send a WE_MATCH message to the compatible device. The WE_MATCH message will contain the contents, if any, of the handle section of the matched profile. The device 10 will receive a corresponding WE_MATCH message from the compatible device and will proceed to S21. The content and format of the WE_MATCH message could depend on the selected profile type. In cases where the device or compatible device has multiple active instances of the same profile, the WE_MATCH message could contain handle details for all two-way matches identified.

On receipt of the WE_MATCH message, the user is then presented with any additional pertinent information, as supplied by the optional fields of the handle section of the compatible device. This information could be displayed on the LCD screen 50 and could be appended to the two-way match log.

At any time while in Matched Mode (S21), or Probe mode (S27) the user of the device 10 can blacklist the user of the compatible device by pressing the blacklist button 62 on the keypad 60 of the device 10. The ID of the compatible device is then added to the Blacklist Cache 36 of the device 10 at stage S20. The device 10 then returns to the polling state via step S3, where a GOODBYE message is sent.

A user may want to blacklist another user for a number of reasons. For example, once a physical meeting has occurred between the two users, the user of the device 10 may decide that they never want to be matched again with the user of the compatible device, based on any profile or set of requirements.

Matched mode (S21) could be cancelled at any time by use of the cancel button 67 on the keypad 60 (S22). This causes the device to proceed to step S7 of FIG. 4, and add the ID of the compatible device to the Recent Encounters Cache 35.

While in matched mode, both users can try and physically locate each other. In embodiments in which a short range communications technology is used, physically locating the user of the compatible device may be trivial due to the relatively small distances involved. However, the location of the other user might not be trivial, if for example, the users are in a crowded area such as a night-club, or busy street. Similar difficulties in locating each other may be experienced by users if a long range communications technology is used. In such situations, the optional probe facility may be employed to assist the actual physical meeting of the users.

In embodiments where the probe facility is present, the user may receive a Probe Request message from the compatible device. This could occur if the user of the compatible device is experiencing difficulties in locating the matched user of the device 10. The user is then alerted to the probe request (S23) by means of a probe alert, which could comprise any combination of an audible alert produced by the speaker 54, a vibrating alert produced by the vibrator 55, and a visual alert on the LCD screen 50, or one or more flashing LEDs. At Step S24, the user can then accept, reject or simply ignore the probe request. If the user wishes to reject the probe request, the Probe reject button 65 on the keypad 60 is pressed, the device 10 sends a Probe Reject message (S28), and the device 10 returns to matched mode (S21).

If the user wishes to accept the probe request, the Probe Accept button 64 on the keypad 60 is pressed. The device 10 then sends a Probe Accepted message to the compatible device at S25. The device 10 will then progress to S27 and both devices will initiate probe mode.

Similarly, the user can try and enter probe mode by pressing the Probe button 63 on the keypad 60 while in matched mode (S21). The device 10 then sends a Probe request message (S26) to the compatible device, and the user of the compatible device can decide to send a Probe Accept message, a Probe Reject Message, or do nothing.

If a Probe Accept message is received by the device 10 at S29, the device 10 initiates probe mode and progresses to S27. If a Probe Reject message is received at S29, the device 10 returns to Matched Mode (S21). If the user of the compatible device ignores the probe message, then the device 10 will remain at S26 until the device 10 times out, at which point the device 10 returns to Matched Mode (S21).

In probe mode both devices will employ audible indication, visual indication, vibrating indication or a combination of the three to allow the users to locate each other. The audible indication could take the form of a probe indicator tone, which could be suitable sound to audibly facilitate the physical meeting of the users. The visual indication could take the form of one or more flashing probe indicator lights. The vibrating indication could take the form of a vibration produced by the vibrator 55.

Optionally the device 10 could allow the pressing of the Probe button 63 while in Probe mode (S27) to cause the compatible device to indicate a further probe alert to its user. Repeated pressing of the Probe button 63 could allow for repeated probe alerts. The repeated probe alerts could allow each user to locate each other easily.

In integrated embodiments, such as devices integrated into mobile telephones, the user could be able communicate directly with the user of the compatible device. This could take the form of sending text messages over the wireless network, or similarly making a voice call.

In addition to the described two-way match log, the device 10 could store details of every interaction with a compatible device, including those that failed to produce a match, in the log 37. This data could be uploaded to the user's PC for periodic analysis of number of encounters, number of matches, number of non-matches, and the specific fields in specific profiles causing non matches. Such data could allow a user to amend their requirements or attributes to try and encourage more matches.

Even if a two-way match has been established for one active profile, while in Matched Mode (S21), the device 10 and the compatible device will continue to process any remaining common active profiles (not shown). The device 10 and the compatible device will proceed through the common active profile list, exchanging and checking requirements for any additional matches. Any additional two-way matches established in this way will be indicated to the user in the manner described above.

The embodiments of the invention thus far described have employed a method of matching of users based on profiles that treat all users of compatible devices in the same way. Such profiles are termed “symmetric profiles”, as matching is attempted based on a set of requirements and attributes fields that are equal in shape and size as between both users, i.e. the users of the device and-the compatible device will have both populated the same set of attributes and requirements fields.

A symmetric profile comprises at least one requirement field for every corresponding attribute field. Furthermore, there will be one instance of the attributes section and one instance of the requirements section per populated profile. The list of attribute fields will not necessarily be the same as the list of requirements fields, and for example two requirements could be matched against a single attribute (e.g. an include list and an exclude list).

However, in other embodiments of the invention, one party's requirements may be less restrictive than the other's. For example, a house hunter who wishes to buy a house will be seeking a specific type of property, based on strict criteria. This could include information such as price, number of rooms, and location of the property. The house hunter could be interested in being matched with every property on the estate agent's books that match their house requirements.

An estate agent may have many properties on their books, and wish to be matched with every user who is looking to buy or rent one of their properties. In order to satisfy the needs of both the house hunter and the estate agent, asymmetric profiles can be used. Asymmetric profiles contain a field to distinguish the finder of something from the provider of something.

Asymmetric profiles are distinguished from symmetric profiles by having two variants of each profile, one for the finder and one for the provider. For every attribute field in the provider variant there is at least one corresponding requirement field in the finder variant. The same is true of the attributes in the finder and the requirements in the provider, but these will generally be minimal. The finder-provider nature of asymmetric profiles contrasts to the finder-finder nature of symmetric profiles, as illustrated in FIG. 8. For the symmetric profile: Finder A and Finder B both have attributes fields and requirements fields of the same size and shape. For the asymmetric profile: Finder A has only one attribute field, whereas Provider B has multiple instances of the attributes field, which is of a different size and shape. Similarly, Finder A's requirements field is of a different size and shape to Provider B's requirements field.

A key characteristic of an asymmetric profile is that the provider party can populate multiple instances of the attributes section in a profile. For example an Estate Agent can populate as many attribute sets as there are properties on their books.

The following are examples of asymmetric profiles:

Property Finder Profile: the object of this profile is to aid a user to find a suitable property to rent or buy. A user enters their property requirements into the requirements fields. These could range from whether they are interested in a flat or a house, the number of bedrooms, and a price range, to far more specific preferences such as: open plan, modern, rear facing master bedroom, decorative order. As the user becomes proximate an Estate Agent, or vendor, equipped with a compatible device, the user will be alerted to any properties that match their requirements.

Book Finder Profile: the object of this profile is to aid a user to find a specific book or books that they are looking for. For example, a user could enter the ISBN numbers or Titles or Authors of the book or books that they are looking for, and as the user becomes proximate a suitably equipped bookstore, they are alerted if any of their listed books are in stock. Furthermore, they may be provided with additional details, such as the precise location of the book or books within the store and its or their price.

As discussed, asymmetric profiles are typically used in the situation in which one user is a finder, and the other is a provider. In the example of the Property Finder Profile, the estate agent is the provider, and the house-hunter the finder. For the Book Finder Profile, the bookseller is the provider, and the book shopper the finder.

FIG. 7 illustrates the situation of communication between two compatible devices according to an embodiment of the invention, respectively owned by a potential customer and a vendor. The potential customer is the finder and the vendor the provider. The potential customer could possess a portable application-specific device 10 or a device integrated with an existing device such as a mobile telephone or PDA.

Similarly, the vendor could also possess such a portable device 10. However, it would be practical for the vendor to possess a fixed compatible device 200 located in their shop or workplace. The fixed compatible device 200 could comprise a PC, workstation, server, or terminal comprising suitable hardware and software adapted to communicate with the portable devices of potential customers. The fixed compatible device 200 could furthermore comprise many of the features of the portable device 10, described with reference to FIG. 2. The functions of the display 50, alert means 51, memory 30 and keypad 60 could all be performed by existing features of the vendor's PC, workstation, server, or terminal.

The fixed compatible device also comprises a transceiver, to allow for communication with compatible devices. This could be in the form of an internal or external unit. The transceiver could be similar in design to those comprised in the application-specific or integrated devices previously described with reference to FIG. 2.

The fixed compatible device 200 comprises suitable software to allow the vendor to store and populate profiles suitable for use with this embodiment. Although, it is envisaged that the profiles used in this embodiment are of the asymmetric finder-provider type, this embodiment of the invention is not limited in this way, and there is no reason why either the provider or finder could not simultaneously employ a mixture of symmetric and asymmetric profiles.

For example, if a user of a portable device 10 wishes to find a property they may populate and upload the Property Finder Profile to their device in the manner described above. This could involve the use of the user's PC, if the user possesses an application-specific device. The user could then activate the Property Finder Profile and go about their daily life.

With the Property Finder Profile active, the user's device 10 actively and unobtrusively attempts to seek out compatible devices with the Property Finder Profile similarly active, whose attributes match the user's requirements, using the short range communications capability of the device 10.

The process by which the devices establish exclusive dialogue in this embodiment is generally similar to that previously described with reference to FIGS. 4 and 5. However, as the Property Finder Profile is an asymmetric profile, there are important differences in the matching process.

In a symmetric profile, a match will not be established unless the sent requirements of the user match the stored attributes of the user of the compatible device, and the sent requirements of the user of the compatible device match the stored attributes of the user. This corresponds to a two-way match. Similarly, when using an asymmetric profile, neither device will enter the matched mode until a two-way match has been established. However, there are different criteria for an I_MATCH message to be sent from the device 10 of the user designated the finder, and the device 200 of the user designated the provider.

In the example of a house hunter wanting to buy a house, the Property Finder Profile stored on the house hunter's device 10 will contain a field that indicates that this user is designated a finder. Correspondingly, the Property Finder Profile stored in the estate agent's device 200 will contain a field that indicates that the estate agent is designated the provider.

The requirements section of the house hunter's Property Finder Profile stored on their device will contain detailed information about their property requirements. The requirements section of the estate agents device 200 will contain information indicating that they are interested in obtaining a match with any house hunter who is interested in matching with one of their properties.

If the house hunter is interested in buying a 2 bedroom house with a garden, the house hunter's device 10 will try and obtain a match with the device 200 of any estate agent who has such a house or houses in the attributes section of their Property Finder Profile. If the house hunter comes into range of an estate agent's device 200, the house hunter's device 10 will enter into dialogue with the estate agent's device 200.

The caches of each device will be checked, and if the IDs of both devices were not present in either cache of either device, the sorted list of active profiles will be exchanged. As discussed, the matching process is generally similar to that described above for symmetric profiles. However, the matching process for the provider, in this case the estate agent, may have to loop through checking a single set of received requirements against multiple stored attribute sets (corresponding to all their properties).

If the estate agent has a suitable property, an I_MATCH message will be sent by the estate agent's device 200. If the estate agent has no suitable properties, an I_DON'T_MATCH message will be sent. In the case of the Property Finder Profile, the requirements of the estate agent are minimal, as they wish to match with as many house hunters as they can. Hence, the house hunter's device 10 will send an I_MATCH signal.

If both devices have sent and received I_MATCH signals, a two-way match has been established, and both devices enter matched mode. Both devices will then send WE_MATCH signals, which may vary from profile to profile, and could include the profile's handle. For example, in the case of the Property Finder Profile the handle sent from the estate agent's device 200 could comprise a contact telephone number, web address or location of the estate agent, together with some details or reference numbers of all the matched properties.

The estate agent could have multiple instances of the Property Finder Profile active to correspond to every property on their books. More preferably, all of their properties could be listed as multiple instances of the attributes section of one profile. As discussed, the ability to include multiple instances of the attribute data within the attributes section of a provider's profile is a key feature of asymmetric profiles.

In the case of the Book Finder Profile, the finder would be a potential book purchaser and the provider a book seller. For example, the finder could populate the Book Finder Profile with data corresponding to the books they are interested in buying, and possibly at what price. The provider could list all the books they currently have in stock with their prices.

If the book purchaser passes within range of the book seller, then the respective devices will enter into a dialogue. If the book seller stocks the book or books that the potential book purchaser is interested in, then the book seller's device 200 will send an I_MATCH signal. As the Book Finder Profile is of the asymmetric type, the book seller is interested in matching with any potential book purchaser, and hence the book sellers sent requirements will be minimal. Hence, the book purchaser's device 10 will send an I_MATCH message. A WE_MATCH message will be sent from both devices. The handle within the WE_MATCH message sent from the book seller could contain information such as the price and location of the book within the store.

The two examples of asymmetric profiles discussed would both normally be associated with the situation in which the requirements sent by the provider will be minimal. However, this will not always be the case, an example being a Pet Finder Profile run by a Veterinary Hospital. For example, a finder could only be qualified for a match if they had a garden or could afford Veterinary bills.

A further embodiment of the invention could comprise an adaptation of the portable device 10, described with reference to FIG. 2, especially for the use of children.

This embodiment can be adapted to be only operable with profiles designed especially and specifically for children. This would ensure that the device meets the particular needs of children. An example of a profile suitable for use with the children's embodiment is given below:

Swap Shop Profile: the object of this profile for use with the children's embodiment is to aid a user to find another user to make a swap with. A user enters the details of what items they are wishing to swap, which are stored in the attributes section. The user also enters the search criteria in the requirements section, which contains items that they are interested making a swap for. This profile could be used to swap trading cards or other children's collectable times.

Friend Finder Profile: The object of this profile for use with the children's embodiment is to aid a user to initiate a friendship with another user. A user enters their personal details, which are stored in the attributes section. The user also enters the search criteria in the requirements section, including what sort of user they are interested in making friends with. This profile could function as a scaled down child-friendly equivalent to the Relationship Finder Profile used with the adult embodiments.

In order to provide extra safeguards against unscrupulous use of devices concerning children, only profiles designed specifically for use with the children's profile will run on the children's embodiment. Adult orientated Profiles such as the Relationship Finder Profile are inoperable on the children's embodiment. Certain child friendly profiles, such as the Book Finder Profile, can be allowed to be used on all embodiments of the invention, including the children's embodiment.

For this to be implemented, the hardware of devices for use with the children's embodiment are locked to only store profiles that have a predetermined children's embodiment flag encoded in the profile ID. This flag comprises a number of bits of the Profile ID, which are reserved as profile “Embodiment Identifiers”. One bit is used to identify an “Adult” embodiment of a profile, while another bit is used to identify a “Children's” embodiment of a profile. Further bits may be reserved for other possible characteristics. Any profile with the adult bit set will function on any adult embodiment of the device. Similarly, any profile with the children's bit set will function on any children's variant of the device. Some profiles, for example the Book Finder Profile could have both of these bits set and would therefore function on both adult and children's variants of the device. As these bits are contained within the Profile ID, any hacking of this Profile ID will make it a different profile and hence will not match with the un-hacked profile ID. This provides a safeguard against unscrupulous use of the children's embodiment.

The remainder of the hardware used in the children's embodiment is substantially similar to the application-specific or integrated portable devices described above. The matching process is similar to that described above, only allowing children's profiles to be matched against other children's profiles. Other restrictions could be placed on the use of certain profiles on certain user's devices. For example, a device 10 issued by an employer to its employees could be set to accept only work related profiles.

Aside from the enforced limitations associated with the children's embodiment, there are in general no limits to the type of data that a profile can be populated with. As discussed, profiles are self-describing data files. The self-describing nature of the profiles allows new varieties of profiles to be created and distributed to users of existing devices. By connecting to the Internet, either via a PC or on an integrated device, a user may download new profiles for use with their device.

New profiles could be created by 3^{rd} parties, who could develop and distribute their own profile types. While these 3^{rd} party profiles could be highly complex, they could be very simple. In its simplest form a profile could comprise nothing more than the unique ID of the profile. In such a case, a two-way match would be established when any two devices with such a profile active attempted to match.

An example of a 3^{rd} Party profile could be a Conference Profile. The organizers of a Conference could include on their conference web page a link to download their 3^{rd} Party Conference Profile. The unique profile ID of this profile could, by itself, serve as a means of identifying other attendees of the conference. In this case, attendees of the conference would be able to download the Conference Profile to their devices and activate it to help identify and socialize with other conference attendees as they wander around the town or city in which it is located.

Such 3^{rd} party Profiles could easily be extended to other areas. A nightclub might, for example, provide a specially tailored Relationship Finder Profile that allows its patrons to socialize in novel ways. Such Profiles could also serve to enable special competitions and other activities based on the contents of predetermined fields within the profile.

Although it has been stated that an advantage of the present invention is that it does not rely on a centralised system to store details of the users and perform matches, embodiments of the invention could be integrated within a centralised infrastructure. This centralised infrastructure could provide a location aware telecommunications network, for example, using 3G communications technology. Using such a centralised infrastructure, the device 10 could be used to populate and select the profiles and alert users to the matches. A central database could store the profiles (by upload from the device) and perform matches based on the location of the users. The location information of each user could be relayed to the central database by the location aware telecommunications network.

An example of a data structure for the profiles discussed above will now be described. In this example, the profile is made up of a collection of fields, and each profile type comprises at least the following main elements: the header, attributes, requirements, and the handle.

All Fields will have the following characteristics, the function of which will sometimes depend on the context in which they appear, i.e. whether the field is located within the attributes section or the requirements section of the profile. Table 1 shows an example field structure.

TABLE 1
Field Structure.

| | Context | |
|---|---|---|
| Characteristic | Attributes | Requirements |
| Field Type | Identifies the type of field, | Same as attributes |
| | so that device and the user | |
| | interface know how to | |
| | process it | |
| Field ID | Identifies this attribute field | Contains the Field ID |
| | uniquely within the Profile | of the attribute against |
| | | which it is to be |
| | | compared to |
| | | establish a match |
| Field Name | Name of this field, as | Same as attributes |
| | presented to the owner in | |
| | the context of this profile | |
| Mandatory Flag | Identifies this field as | When set to True, do |
| | Mandatory or Optional (i.e. | NOT match with users |
| | whether or not the user | who have not entered |
| | MUST supply data) | any data for this field. |
| | | When set to False, |
| | | ALWAYS match with |
| | | users who have not |
| | | entered any data for |
| | | this field. |
| Intrinsic Values | This defines the types of | Same as attributes |
| | values this field type | |
| | supports - for example, | |
| | with a Boolean field type, | |
| | the intrinsic values would | |
| | be True or False | |
| Selected Values | The values selected by the | Same as attributes |
| | owner populating this | |
| | profile | |
| Finder/Provider flag | For Asymmetric type | Same as attributes |
| | Profiles, this is used to | |
| | specify if this field is valid | |
| | for population by the finder | |
| | party, the provider party, or | |
| | both parties. For all other | |
| | (i.e. symmetric) profiles, | |
| | this will always be NULL. | |
| Type Specific | . . . | . . . |
| Characteristics . . . | | |
| . | . | . |
| . | . | . |
| . | . | . |

The Field ID is used to uniquely identify a field within the attributes section of a profile, and is used by all of the corresponding requirements fields to identify the relevant attributes fields.

For symmetric profiles, the attributes and requirements elements of a profile are built from a set of fields that are mirrored for both users.

For asymmetric profiles, such as the Property Finder Profile, the attributes and requirements sections of the profile are substantially different.

The header of the profile includes the profile ID that uniquely identifies the profile type. The use of profile IDs allows a device to identify common active profiles sent by compatible devices, when locked in exclusive dialogue. The header can also be used to flag if the profile is symmetric or asymmetric, or if the profile is not suitable for use by children. This is preferably encoded within the profile ID as a number of bits comprising an embodiment identifier. In order for every profile to be readable on every device (subject to the restrictions associated with children) the header has a predetermined and non-configurable format. Therefore, any user created profile will be capable of being processed on any device according to the invention. The profile header can also be used to store the timing information that indicates the predetermined active period of the profile.

The attributes section of a profile can comprise a variable set of attributes fields. As discussed, the attributes typically contain personal information of the user. For asymmetric profiles, the first attributes field can indicate whether the user of the device is a finder or a provider. How the remaining fields are populated and presented will depend on the contents of this field. In some embodiments of the invention it may be desirable to reference the attributes of the user with an external database. For example, an estate agent, with a fixed device 200 set up to run the Property Finder Profile, may desire to link the attributes of this profile, which contains details of the properties on their books, to a central database containing their list of properties. Alternatively a chain of book stores, with a fixed device 200 set up to run the Book Finder Profile in each store, may desire to link the list of books in stock in each store to a central stock taking database. In such a situation, the link could be achieved by using a wide area network or the Internet.

The requirements section of a profile may comprise a variable set of search criteria fields. As discussed, unlike the attributes of the user, the requirements are sent to other devices during the matching process.

The handle will comprise the information sent to the user of the compatible device when a two-way match is established. As discussed, the use of a handle is optional.

The software used to populate the profiles, whether on a PC or on an integrated device, recognises each field type, and accordingly generates the appropriate forms and presents the data in an appropriate way to the user. The device similarly recognises the field type, and uses this information to apply the correct algorithm when matching, in order to obtain a match or no match result for each field. The use of pre-defined field types allows the device to parse any legally constructed profile, built from any combination of fields. Hence, as discussed, a 3^{rd} party could create and distribute a profile to suit any particular need.

In order to prevent malicious 3^{rd} parties from creating unsuitable profiles for use with the children's embodiment of the invention, it is not possible for a malicious party to download and activate a profile on another user's device 10. A profile of any sort will only be useful if it can be distributed and activated on user's devices.

Certain fields in a profile may be allowed to be kept unpopulated, i.e. blank. For example, a user may not wish to enter their age or salary into the attributes field of a Relationship Finder Profile. When a user enters their requirements for such an individual field that can be kept blank, they are given the option of specifying whether or not this field be considered mandatory or not. This will set the mandatory flag for the field to “true” or “false”. Selecting that an individual requirements field be mandatory will result in blank fields in other user's attributes never returning a match. Conversely, selecting that a requirements field is not mandatory will always result in a match being indicated with corresponding blank attribute fields.

The function of a field can depend on the context in which it appears. For example, a field may have a different function if it is located in the attributes or requirements section of the profile. Several example field types will now be discussed with reference to Tables 2 to 11. In these tables, the selected values are those that are filled in by the user when a profile is populated.

TABLE 2
Finder-Provider Definition:

Context

| Characteristic | Attributes | Requirements |
|---|---|---|
| Field Type | Finder-Provider | Not Applicable |
| Intrinsic Value/s | Finder, Provider | Not Applicable |
| Selected Values | One of Finder or Provider | Not Applicable |

The finder-provider field type occurs as the first field in the Attributes section of every asymmetric profile. It is used to identify whether the user populating the profile is designating themselves a finder or a provider. The value entered in this field is then used to determine which other fields are presented to the user for population.

The Boolean field type records True/False information, as illustrated in Table 3, with an example in Table 4.

TABLE 3
Boolean Definition:

| | Context | |
|---|---|---|
| Characteristic | Attributes | Requirements |
| Field Type | Boolean | Boolean |
| Intrinsic Value/s | True, False, Null | True, False, Null |
| Selected Values | One of True, False, NULL | One of True, False, |
| | | NULL |

TABLE 4
Boolean Example:

| | Context | |
|---|---|---|
| Characteristic | Attributes | Requirements |
| Field Type | Boolean | Boolean |
| Name | Vegetarian | Vegetarian |
| Selected Values | True | NULL |
| Meaning | The owner is a | The owner does not care if the other |
| | Vegetarian | party is a Vegetarian |

The integer numeric field type records and matches attributes and requirements based on integer numeric information. In the illustration of an integer numeric field type in Table 5, the user can enter a minimum/maximum pair of values. If the user desires to enter an absolute value, the apparatus populating the field would set both the minimum and maximum values to be identical. Table 6 shows an illustrative example of an integer numeric field type field, from within an asymmetric profile.

TABLE 5
Integer Numeric Definition:

| | Context | |
|---|---|---|
| Characteristic | Attributes | Requirements |
| Field Type | Numeric | Numeric |
| Value Type | Integer, Null | A Pair of Integers or NULL |
| Selected Values | A number of type | N/A |
| | Integer, or Null | |
| Minimum Value | N/A | A number of type Integer, or Null |
| Maximum Value | N/A | A number of type Integer, or Null |

TABLE 6
Integer Numeric Example from an asymmetric profile:

| | Context | |
|---|---|---|
| | Attributes (from a | REQUIREMENTS |
| Characteristic | Provider Profile) | (from a Finder Profile) |
| Field Type | Numeric | Numeric |
| Name | Wine's Vintage | Wine's Vintage |
| Selected Values | 1947 | N/A |
| Minimum Value | N/A | NULL |
| Maximum Value | N/A | 1955 |
| Meaning | This owner is selling a | This owner is looking for a |
| | particular wine whose | wine of a vintage no |
| | vintage is 1947 | later than 1955 |

The Selection field type allows the user to select from a pre-defined list of alternative values. The creator of the profile structure can implement a One/Many Flag characteristic to distinguish between lists that require only one value to be selected, and those in which multiple values can be selected. The creator of the profile structure can also implement the Include/Exclude Flag within the requirements section of the profile to allow the user to explicitly match (include) or fail (exclude) against particular attributes.

TABLE 7
Selection Definition:

| | CONTEXT | |
|---|---|---|
| Characteristic | Attributes | Requirements |
| Field Type | Selection | Selection |
| Intrinsic Value/s | Variable length list | List of strings obtained |
| | of Strings | from the referenced |
| | | ATTRIBUTES field |
| One/Many Flag | One, Many | One, Many |
| Selected Values | List of Strings | List of Strings (a subset of |
| | (a subset of Intrinsic | Intrinsic values) |
| | values) | |
| Include/Exclude Flag | NULL | Include, Exclude, NULL |
| AND/OR Flag | NULL | AND, OR, NULL |

Two examples of the selection field type will now be illustrated in Tables 8 and 9. In Table 8 the creator of the profile has included two separate requirement instantiations for the Hobbies field, one for included items and another for excluded items.

TABLE 8
Selection Example 1

| | CONTEXT | | |
|---|---|---|---|
| Characteristic | Attributes | Requirements | Requirements 2 |
| Field Type | Selection | Selection | Selection |
| Name | Hobbies | Hobbies | Hobbies |
| Legal Values (as | “sport”, “theater”, | * | * |
| provided by the | “reading”, “long | | |
| Profile's author) | walks” | | |
| One/Many Flag | Many | Many | Many |
| Selected Values | “sport”, “reading” | “theater” | “long walks” |
| | | “reading” | |
| Include/Exclude | N/A | Include | Exclude |
| Flag | | | |
| AND/OR Flag | N/A | AND | OR (Default) |
| Meaning | Owner likes sport | Owner looking | Owner wishes |
| | and reading | for someone | to exclude anyone |
| | | who likes both | who likes long |
| | | theater and | walks |
| | | reading | |

“*” = The list is referenced automatically from the Attributes field within the profile using the Field ID

Table 9 illustrates field from a “Last Minute Holidays” Profile, as could be authored and distributed by a chain of travel agents.

TABLE 9
Selection Example 2

| | CONTEXT | | |
|---|---|---|---|
| Characteristic | Attributes | Requirements | Requirements 2 |
| Field Type | Selection | Selection | Selection |
| Name | Destination | Destination | Destination |
| Legal Values | “Greece”, | * | * |
| | “Canaries”, | | |
| | “Spain”, | | |
| | “Turkey”, . . . | | |
| One/Many Flag | One | Many | Many |
| Selected | “Greece” | ALL | “Spain”, |
| Values | | | “Turkey” |
| Include/ | N/A | Include | Exclude |
| Exclude Flag | | | |
| AND/OR Flag | N/A | OR | OR |
| Meaning | This owner/vendor | This owner is | . . . except |
| | is offering a last- | looking for a | Spain or |
| | minute holiday to | Holiday to any | Turkey |
| | Greece | of the listed | |
| | | destinations . . . | |

“*” = The list is referenced automatically from the Attributes field within the profile

In the example field type shown in Table 9, the AND/OR Flag will not be presented to the user as an option when specifying their requirements. The apparatus used to populate a profile containing this field type will recognise that when the attributes field allows only ‘One’ value, the use of an AND operator would have no meaning. Furthermore, the provision by the creator of the profile of an Exclude field (in addition to the Include field) for the Destination is logically redundant. This is because the user populating the profile could have simply omitted both Spain and Turkey from their Include selection. However, here the creator of the profile has provided it for enhanced usability.

Fields of type Keyword allow users to specify a set of keywords, which are in effect free text that can be matched against, and are illustrated in Tables 10 and 11. This could allow a profile to be extended beyond the confines of its original design. For example, a Swap Shop Profile for use with the children's embodiment of the invention could never be designed to encompass the vast and ever changing array of items that may be bartered or swapped in the melee of the playground.

The provision of keyword field type allows users to extend their existing profiles to suit their needs. This reduces the need for new profiles to be designed and distributed. Furthermore, it could allow, for example, communities of people to develop and use special code words.

TABLE 10
Keyword Definition:

| | CONTEXT | |
|---|---|---|
| Characteristic | Attributes | Requirements |
| Field Type | Keyword | Keyword |
| Intrinsic Value/s | Blank variable length list | Blank variable length list of |
| | of Strings | Strings |
| Entered Values | List of Strings | List of Strings |
| Exclude Flag | N/A | True, False, NULL |
| AND Flag | N/A | True, False, NULL |

An example of a keyword type field for use in a Swap Shop Profile is given in Table 11.

TABLE 11
Keyword Example:

| | CONTEXT | | |
|---|---|---|---|
| Characteristic | Attributes | Requirements | Requirements 2 |
| Field Type | Keyword | Keyword | Keyword |
| Name | Item/s to Swap | Item to Swap | Item to Swap |
| Contextual | Blank variable | Blank variable | Blank variable |
| Values | length list | length list | length list |
| | of Strings | of Strings | of Strings |
| Entered Values | “Toy A” | “Toy B” “Card C” | “” |
| Exclude Flag | N/A | False | True |
| AND Flag | N/A | False | False |
| Meaning | The owner | This owner is | The owner is not |
| | has a Toy A | looking for | excluding |
| | to swap | anything to do | anything |
| | | with Toy A or | |
| | | Card C | |

The above field types are only exemplary, and it will be apparent that many additions or modifications to the above are possible. For example, other field types could include Date, Time, Exact Text and Floating Point Numeric.

The present invention has been described above purely by way of example, and those skilled in the art will recognise that many modifications can be made within the scope of the invention. The invention also consists in any individual features described or implicit herein or shown or implicit in the drawings or any combination of any such features or any generalisation of any such features or combination, which extends to equivalents thereof.

Furthermore, although embodiments of the invention have been discussed that rely on users physically locating each other after a match has been established either unaided, or using the optional probe mode, other embodiments of the invention could relay detailed positional information to the user. This would require the use of a communications technology capable of relaying positional information, such as 3G.

1. A communications device comprising:
a memory adapted to store at least one profile of a user of the device, wherein the said at least one profile contains predetermined attributes and requirements of the user,
a transceiver adapted to transmit information relating to the said requirements to a compatible device and receive information relating to requirements of the said compatible device;
a controller adapted to register a match between the said device and the said compatible device, only when the said attributes match the said requirements of the said compatible device; and
a user alert adapted to alert a user when the controller has established that a match has been made;
wherein the transceiver is further adapted to transmit a first match signal to the compatible device when the controller has established that a match has been made;
wherein the said device does not need to receive information relating to attributes of the said compatible device, in order to register a match with the said compatible device.

2. A communications device according to claim 1, wherein the user alert is further adapted to alert the user only when the controller has established that a match has been made and that a match signal has been received from the compatible device, said match signal indicating that the compatible device has registered a corresponding match.

3. A communications device according to claim 1 or 2, wherein the device further comprises a display.

4. A communications device according to claim 3, wherein the display is adapted to display an indication of the or each profile stored in the device.

5. A communications device according to claim 4, wherein the device is further adapted to allow the user to designate which of the stored at least one profiles the user designates as active; the said memory is further adapted to store an indication of the active profile or profiles; and the communicator is further adapted to exchange information with a compatible device based only on the active profile or profiles.

6. A communications device according to claim 5, wherein the device further comprises a keypad, said keypad being adapted to allow a user to activate a profile from those stored in the device.

7. A communications device according to claim 5 or 6, wherein the display is further adapted to display an indication of the active profiles.

8. A communications device according to any preceding claim, wherein the memory comprises a combination of volatile and non-volatile memory.

9. A communications device according to any preceding claim, wherein the user alert is adapted to provide a visual indication to the user.

10. A communications device according to claim 9 when dependent on claim 3, wherein the user alert is adapted to provide the visual indication using the display.

11. A communications device according to claim 9, wherein the user alert comprises at least one LED.

12. A communications device according to any preceding claim, wherein the user alert is adapted to provide an audible indication to the user.

13. A communications device according to any preceding claim, wherein the user alert is adapted to provide a vibrating indication to the user.

14. A communications device according to any preceding claim, wherein the or each said profile comprises a self-describing data file, each self-describing data file comprising at least one field.

15. A communications device according to any preceding claim, wherein the or each said profile comprises at least one of a plurality of possible field types.

16. A communications device according to any preceding claim, wherein the or each said profile comprises one or more sets of fields of a keyword type, said one or more sets of fields allowing matching to be performed against user determined free text.

17. A communications device according to any preceding claim, wherein the or each said profile comprises a field that can contain a mandatory flag, the said mandatory flag indicating to the device whether blank fields are required to always or never be matched against.

18. A communications device according to any preceding claim, wherein the memory is adapted to store multiple instances of the same profile type; wherein the device is adapted to: match all the multiple instances of the same profile in a matching process that involves transmitting a two dimensional matrix of flags that indicate a match or no match, the columns of said matrix being indexed on the instances of the profile stored in the memory; receive a corresponding two dimensional matrix from the compatible device; transform the received matrix; and compare the transformed received matrix with the sent matrix to identify any and all matches for this profile type.

19. A communications device according to any preceding claim, wherein the or each said profile comprises a header section, the header section comprising a unique profile ID of the respective profile.

20. A communications device according to claim 19, wherein the header section is the only section of the or each said profile that cannot be modified by the user.

21. A communications device according to any preceding claim, wherein the attributes and requirements of the or each said profile are determined by the user.

22. A communications device according to any preceding claim, wherein the device is adapted to communicate with a suitably programmed computer.

23. A communications device according to claim 22, wherein the device is adapted to communicate with the suitably programmed computer using a cable connection between the device and the suitably programmed computer.

24. A communications device according to claim 22, wherein the device is adapted to communicate with the suitably programmed computer using the said transceiver.

25. A communications device according to any of claims 22 to 24, wherein the said device is adapted to store the populated at least one profile, upon receipt of information relating to the said attributes and requirements from the said computer.

26. A communications device according to one of claims 22 to 25, wherein the said device is adapted to store new profile types, upon receipt of information relating to the said new profile types from the said suitably programmed computer.

27. A communications device according to claim 26, wherein the said information relating to the said new profile types has been downloaded to the said suitably programmed computer from any of the Internet, an email attachment, or a MMS attachment.

28. A communications device according to any preceding claim, wherein the device further comprises a timer and a timing register, and wherein the timing register is adapted to store timing information for the or each said profile.

29. A communications device according to claim 28, wherein the timing information comprises a predetermined active period for the or each said profile.

30. A communications device according to claim 27 or 28, wherein the timing information comprises a schedule relating to the activation and deactivation of the or each said profile at user defined times.

31. A communications device according to any preceding claim, wherein the device is further adapted to store a unique ID of the device.

32. A communications device according to any preceding claim, wherein the memory comprises a recent encounters cache, the said recent encounters cache comprising a list of received unique IDs of compatible devices that have communicated with the device.

33. A communications device according to any preceding claim, wherein the device is further adapted to allow the user to blacklist compatible devices after the establishment of a match, and wherein the memory comprises a blacklist cache, the said blacklist cache comprising a list of received unique IDs of compatible devices that the user has blacklisted.

34. A communications device according to any preceding claim, wherein the device further comprises a probe alert, the said probe alert being adapted to aid the user physically to locate the user of the compatible device once a match has been established.

35. A communications device according to claim 34, wherein the said probe alert is adapted to provide a visual location indication to the user.

36. A communications device according to claim 35, wherein the said probe alert comprises at least one LED.

37. A communications device according to one of claims 34 to 36, wherein said probe alert is adapted to provide the visual location indication to the user using the display.

38. A communications device according to one of claims 34 to 37, wherein the said probe alert is adapted to provide an audible location indication.

39. A communications device according to one of claims 34 to 38, wherein the said probe alert is adapted to provide a vibrating location indication.

40. A communications device according to any preceding claim, wherein the device is further adapted to store at least one handle, the or each said handle generally comprising a string of characters, and wherein the device is adapted to enable the or each said handle to be sent to the compatible device on the establishment of a match.

41. A communications device according to claim 40, wherein the or each said handle comprises information pertaining to the established match.

42. A communications device according to any preceding claim, wherein the memory is further adapted to store a match log, the said match log comprising information regarding previously established matches.

43. A communications device according to claim 42 when dependent on claim 40 or 41, wherein the match log comprises a unique ID of each previously matched compatible device along with match information comprised in any received handles.

44. A communications device according to claim 42 or 43, wherein the match log further comprises information regarding details of communications between the device and compatible devices that did not result in a match.

45. A communications device according to any of claims 42 to 44 when dependent on claim 22, wherein the device is further adapted to upload the contents of the match log to the suitably programmed computer.

46. A communications device according to claim 19 or any claim dependent upon claim 19, wherein the memory is adapted to store only profiles that comprise a predetermined flag in the header section.

47. A communications device according to claim 46, wherein the predetermined flag is formed from a number of bits of the Profile ID, and wherein the device is adapted to only match with compatible devices that have at least one stored profile with an identical corresponding bit set of the predetermined flag.

48. A communications device according to any preceding claim, wherein the transceiver is adapted to exchange information with the compatible device using short range wireless communications.

49. A communications device according to claim 48, wherein the short range wireless communications employs radio or microwave transmission.

50. A communications device according to claim 48, wherein the wireless communication employs Bluetooth or Wi-Fi transmission.

51. A communications device according to claim 48, wherein the wireless communication employs any location aware telecommunications network.

52. A communications device according to claim 51, wherein the location aware telecommunications network employs 3G transmission.

53. A communications device according to any preceding claim, wherein the transceiver is adapted to exchange information with the compatible device using long range wireless communications.

54. A communications device according to any preceding claim, wherein the device is a portable device.

55. A communications device according to claim 54, wherein the portable device is any one of, or a combination of: a mobile telephone, a PDA, a pager, a palmtop computer, a notebook computer or a laptop computer.

56. A communications device according to claim 55, wherein the device is further adapted to perform any one of, or a combination of: populating the or each said profile, creating new profiles, connecting to the Internet or accessing email or MMS attachments and downloading new profiles.

57. A communications device according to any of claims 1 to 53, wherein the device is not portable.

58. A communications device according to claim 57, wherein the device is any of: a personal computer, workstation, server, or terminal.

59. A communications device according to claim 57 or 58, wherein the device is adapted to perform any one of, or a combination of: populating the or each said profile, creating new profiles, connecting to the Internet or accessing email of MMS attachments and downloading new profiles.

60. A communications device according to claim 14, or any claim dependent upon claim 14, wherein the memory is adapted to store at least one profile that is a symmetric profile, the said symmetric profile comprising a set of attributes and requirements fields which is adapted to be symmetric with respect to that of a compatible device.

61. A communications device according to claim 14, or any claim dependent upon claim 14, wherein the memory is adapted to store at least one profile that is an asymmetric profile, the said asymmetric profile comprising a set of attributes and requirements fields that is adapted to be asymmetric with respect to that of a compatible device.

62. A communications device according to claim 61 when dependent on claim 19, wherein the device is adapted to store an indication of whether the user is a provider or a finder in the profile.

63. A communications device according to claim 61 or 62, wherein the said asymmetric profile comprises multiple instances of the attributes of the user.

64. A communications device according to any of claims 61 to 63, wherein the device is adapted to populate the attributes of the said asymmetric profile by referencing an external database, the said external database being stored on any of a LAN, a WAN, personal computer, workstation, server, terminal or the Internet.

65. A communications device according to claim 64, wherein the device is adapted to store the results of the reference to the external database after a match has been established, if the user of the compatible device becomes out of range before the user of the device is be alerted to the match; and alert the user to the match if the user of the compatible device becomes in range again within a predetermined time period, without referring to the external database again.

66. A communications device according to claim 51 or any claim dependent on claim 51, wherein the device is adapted to upload the or each said profile to a central database, said central database being adapted to store location information relating to the users; and match users based on the attributes and requirements of the or each said profile and the location information relating to the users.

67. A communications device substantially as hereinbefore described with reference to the accompanying drawings.

68. A communications method comprising the steps of:
storing at least one profile of a user in a memory of a communications device, wherein the or each said profile contains predetermined attributes and requirements of the user;
using a transceiver of the device to transmit information relating to the said requirements to a compatible device and receive information relating to requirements of the said compatible device;
using a controller to register a match between the said device and the said compatible device, only when the said attributes match the said requirements of the said compatible device;
using a user alert to alert a user when the controller has established that a match has been made; and
using the transceiver to transmit a first match signal to the said compatible device when the controller has established that a match has been made;
wherein the said device does not need to receive information relating to attributes of the said compatible device, in order to register a match with the said compatible device.

69. A communications method according to claim 68, wherein the user is alerted only when a match has been registered and a match signal has been received from the compatible device, the said match signal indicating that the compatible device has registered a corresponding match.

70. A communications method according to claim 68 or 69, further comprising the step of using a display to display an indication of the profiles stored in the device.

71. A communications method according to claim 70, further comprising the steps of allowing the user to designate which of the stored at least one profiles are designated as active; storing an indication of the active profile or profiles in the memory; and exchanging information with a compatible device based only on the active profile or profiles.

72. A communications method according to claim 71, further comprising the step of using a keypad to activate a profile from those stored in the device.

73. A communications method according to claim 72, further comprising the step of using the display to display an indication of the active profile or profiles.

74. A communications method according to any of claims 68 to 73, wherein the memory comprises a combination of volatile and non-volatile memory.

75. A communications method according to any of claims 68 to 74, further comprising the step of using the user alert to provide a visual indication to the user.

76. A communications method according to claim 75 when dependent on claim 70, further comprising the step of providing the visual indication using the display.

77. A communications method according to claim 75, further comprising the step of providing the visual indication using at least one LED.

78. A communications method according to any of claims 68 to 77, further comprising the step of using the user alert to provide an audible indication to the user.

79. A communications method according to any of claims 68 to 78, further comprising the step of using the user alert to provide a vibrating indication to the user.

80. A communications method according to any of claims 68 to 79, wherein the or each said profile comprises a self-describing data file, each self-describing data file comprising at least one field.

81. A communications method according to any of claims 68 to 80, wherein the or each said profile comprises at least one of a plurality of possible field types.

82. A communications method according to any of claims 68 to 81, wherein the or each said profile comprises one or more sets of fields of a keyword type, said one or more sets of fields allowing matching to be performed against user determined free text.

83. A communications method according to any of claims 68 to 82, wherein the or each said profile comprises a field that can contain a mandatory flag, the said mandatory flag indicating to the device whether blank fields are required to always or never be matched against.

84. A communications method according to any of claims 68 to 83, further comprising the steps use storing multiple instances of the same profile type in the memory; matching all the multiple instances of the same profile in a matching process that involves transmitting a two dimensional matrix of flags that indicate a match or no match, the columns of said matrix being indexed on the instances of the profile stored in the memory; receiving a corresponding two dimensional matrix from the compatible device; transforming the received matrix; and comparing the transformed received matrix with the sent matrix to identify any and all matches for this profile type.

85. A communications method according to any of claims 68 to 84, wherein the or each said profile comprises a header section, the header section comprising a unique profile ID of the respective profile.

86. A communications method according to claim 85, wherein the header section is the only section of the or each said profile that cannot be modified by the user.

87. A communications method according to any of claims 68 to 86 wherein the user determines the attributes and requirements of the at least one profile.

88. A communications method according to any of claims 65 to 87, wherein the device communicates with a suitably programmed computer.

89. A communications method according to claim 88, wherein the device communicates with the suitably programmed computer using a cable connection between the device and the suitably programmed computer.

90. A communications method according to claim 88, wherein the device communicates with the suitably programmed computer using the said transceiver.

91. A communications method according to any of claims 88 to 90, wherein the device stores the populated at least one profile, upon receipt of information relating to the said attributes and requirements from the said computer.

92. A communications method according to one of claims 88 to 91, wherein the device stores new profile types, upon receipt of information relating to said new profile types from said suitably programmed computer.

93. A communications method according to claim 92, wherein the said information relating to the said new profile types is downloaded to said suitably programmed computer from any of the Internet, an email attachment or MMS attachment.

94. A communications method according to any of claims 68 to 93, further comprising the step of storing timing information for the or each said profile in a timing register.

95. A communications method according to claim 94, wherein the timing information comprises a predetermined active period for the or each said profile.

96. A communications method according to claim 94 or 95, wherein the timing information comprises a schedule relating to the activation and deactivation of the or each said profile at user defined times.

97. A communications method according to any of claims 68 to 96, wherein the device stores a unique ID of the device.

98. A communications method according to any of claims 68 to 97, wherein the memory comprises a recent encounters cache, the said recent encounters cache comprising a list of received unique IDs of compatible devices that have communicated with the device.

99. A communications method according to any of claims 68 to 98 wherein the user can optionally blacklist compatible devices after the establishment of a match, and wherein the memory comprises a blacklist cache, the said blacklist cache comprising a list of received unique IDs of compatible devices that the user has blacklisted.

100. A communications method according to any of claims 68 to 99, further comprising the step of using a probe alert to aid the user to physically locate the user of the compatible device once a match has been established.

101. A communications method according to claim 100, wherein the said probe alert provides a visual location indication to the user.

102. A communications method according to claim 101, wherein the said probe alert comprises at least one LED.

103. A communications method according to any of claims 100 to 102, wherein the said probe alert uses the display to provide the visual location to the user.

104. A communications method according to any of claims 100 to 103, wherein the said probe alert provides an audible location indication to the user.

105. A communications method according to any of claims 100 to 104, wherein the said probe alert provides a vibrating location indication.

106. A communications method according to any of claims 68 to 105, wherein at least one handle of the user is stored in the device, the or each said handle generally comprising a string of characters, and wherein the device sends the or each said handle to the compatible device on the establishment of a match.

107. A communications method according to claim 106, wherein the or each said handle comprises information pertaining to the established match.

108. A communications method according to any of claims 68 to 107, wherein a match log is stored in the memory, the said match log comprising information regarding previously established matches.

109. A communications method according claim 108 when dependent on claim 106 or 107, wherein the match log comprises a unique ID of each previously matched compatible device along with any received handles.

110. A communications method according to claim 108 or 109, wherein the match log further comprises information regarding details of communications between the device and compatible devices that did not result in a match.

111. A communications method according to any of claims 108 to 110 when dependent on claim 88, wherein the device uploads the contents of the match log to the suitably programmed computer.

112. A communications method according to claim 85 or any claim dependent upon claim 85, wherein only profiles that comprise a predetermined flag in the header section are stored in the memory.

113. A communications method according to claim 11 2, wherein the predetermined flag is formed from a number of bits of the Profile ID, and wherein the device only attempts to match with compatible devices that have at least one stored profile with an identical corresponding bit set of the predetermined flag.

114. A communications method according to any of claims 68 to 113, wherein the transceiver exchanges information with the compatible device using short range wireless communications.

115. A communications method according to claim 114, wherein the short range wireless communications employs radio or microwave transmission.

116. A communications method according to claim 114, wherein the wireless communications employs Bluetooth or Wi-Fi transmission.

117. A communications method according to claim 114, wherein the wireless communication employs any location aware telecommunications network.

118. A communications method according to claim 117, wherein the location aware telecommunications network employs 3G transmission.

119. A communications method according to any of claims 68 to 118, wherein the transceiver exchanges information with the compatible device using long range wireless communications.

120. A communications method according to any of claims 68 to 119, wherein the device is a portable device.

121. A communications method according to claim 120, wherein the portable device is any one of or a combination of: a mobile telephone, a PDA, a pager, a palmtop computer, a notebook computer or a laptop computer.

122. A communications method according to claim 121, further comprising the steps of using the portable integrated device to perform any one of, or a combination of: populating the or each said profile, creating new profiles, connecting to the Internet or accessing email or MMS attachments and downloading new profiles.

123. A communications method according to any of claims 68 to 119, wherein the device is not portable.

124. A communications method according to claim 123, wherein the device is any of: a personal computer, workstation, server, or terminal.

125. A communications method according to claim 123 or 124, further comprising the steps of using the device to perform any one of, or a combination of: populating the or each said profile, creating new profiles, connecting to the Internet or accessing email or MMS attachments and downloading new profiles.

126. A communications method according to claim 80, or any claim dependent upon claim 80, wherein at least one profile that is a symmetric profile is stored in the memory, the said symmetric profile comprising a set of attributes and requirements fields which is adapted to be symmetric with respect to that of a compatible device.

127. A communications method according to claim 80, or any claim dependent upon claim 80, wherein the memory is adapted to store at least one profile that is an asymmetric profile, the said asymmetric profile comprising a set of attributes and requirements fields that is adapted to be asymmetric with respect to that of a compatible device.

128. A communications method according to claim 127 when dependent on claim 85, wherein the device is adapted to store an indication of whether the user is a provider or a finder in the profile.

129. A communications method according to claim 127 or 128, wherein the said asymmetric profile comprises multiple instances of the attributes of the user.

130. A communications method according to any of claims 127 to 129, wherein the device populates the attributes of the said asymmetric profile by referencing an external database, the said external database being stored on any of a LAN, a WAN, personal computer, workstation, server, terminal or the Internet.

131. A communications method according to claim 130, further comprising the steps of storing the results of the reference to the external database after a match has been established, if the user of the compatible device becomes out of range before the user of the device is be alerted to the match; and alerting the user to the match if the user of the compatible device becomes in range again within a predetermined time period, without referring to the external database again.

132. A communications method according to claim 117 or any claim dependent on claim 117, further comprising the steps of uploading the or each said profile to a central database, said central database being adapted to store location information relating to the users; and matching users based on the attributes and requirements of the or each said profile and the location information relating to the users.

133. A communications method substantially as hereinbefore described with reference to the accompanying drawings.

134. A communications system comprising at least two communication devices as claimed in claim 60, wherein the controller of each device is respectively adapted to register a match between the device and the other device based on the symmetric profile, wherein the system is adapted to treat the attributes and requirements of each respective user equally.

135. A communications system comprising at least two communication devices as claimed in claim 61, wherein the controller of each device is respectively adapted to register a match between the device and the other device based on the asymmetric profile, wherein the system is adapted to treat the attributes and requirements of each respective user differently.
